(19) United States
(12) Patent Application Publication
(10) Pub. No.: US 2026/0300987 A1
(43) Pub. Date: Oct. 1, 2026

(54) PRODUCT RISK ASSESSMENT

(71) Applicant: Honeywell International Inc., Charlotte, NC (US)

(72) Inventors: Waad Subber, Schenectady, NY (US); Ankit Singh, Apex, NC (US); Lakshminarayana Paila, Frisco, TX (US)

(21) Appl. No.: 19/091,882

(22) Filed: Mar. 27, 2025

(51) Int. Cl. G06Q 30/014

(52) U.S. Cl. CPC G06Q 30/014

(57) ABSTRACT

Approaches for proactive product risk assessment are described. According to one example, forum data available on public forums is parsed to retrieve recall and feedback (RF) data corresponding to a target product. The RF data is analyzed to identify analytical tools to be implemented for assessing the target product and determine an assessment workflow indicating a sequential order of analytical tools to be followed for assessing the target product. Tool-specific input data corresponding to each of the analytical tools may be generated and analyzed to obtain tool-specific output data from each of the analytical tools by implementing the analytical tools in accordance with the sequential order. Tool-specific output data obtained from the analytical tools are processed to identify probable quality concerns in the target product and generate an assessment report, including the probable quality concerns, corresponding to the target product.

### BACKGROUND

Product safety and quality assurance are common concerns across various industries. As products become increasingly complex and global supply chains more intricate, the potential for unforeseen issues that could impact the safety of consumers of the products has grown. Further, as products are used by the consumers in real-world conditions, certain issues may emerge that were not apparent during pre-market testing of the products. Thus, product risk assessment, even after the products reach market, plays a crucial role in identifying potential hazards associated with the products and recalling defective or unsafe products from the market.

### BRIEF DESCRIPTION OF FIGURES

Systems and/or methods are now described, in accordance with examples of the present subject matter and with reference to the accompanying figures, in which:

FIG. 1 illustrates a system for product risk assessment, according to an example;

FIG. 2 illustrates a computing environment implementing the system for product risk assessment, according to another example;

FIG. 3 illustrates a computing environment implementing a risk assessment model for product risk assessment, according to an example;

FIG. 4A, FIG. 4B, FIG. 4C, and FIG. 4D illustrate exemplary output data obtained from various analytical tools implemented by the system for product risk assessment, according to an example;

FIG. 5 illustrates a method of product risk assessment, according to an example;

FIG. 6 illustrates a method of generating input data for various analytical tools to be implemented for product risk assessment, according to an example;

FIG. 7 illustrates a method of generating input data for various analytical tools to be implemented for product risk assessment, according to another example;

FIG. 8 illustrates a method of generating input data for various analytical tools to be implemented for product risk assessment, according to yet another example;

FIG. 9 illustrates a method of generating an assessment report based on the product risk assessment, according to an example;

FIG. 10 illustrates a method of warning about quality concerns identified in a target product, according to an example; and

FIG. 11 illustrates a computing environment implementing a non-transitory computer-readable medium for product risk assessment, according to an example.

### DETAILED DESCRIPTION

Product recalls can result in inconvenience for the consumers and significant monetary losses for manufacturers of recalled products, including direct financial impact of retrieving and replacing the recalled products, as well as indirect financial impact caused due to loss of consumer trust. Additionally, large-scale product recalls can disrupt supply chains, affecting retailers and distributors throughout the product lifecycle. However, not recalling defective or unsafe products may jeopardize consumer's lives and may lead to huge reputational and financial damage, including regulatory penalties or legal repercussions, for the manufacturers. Thus, it is important for an organization to conduct product risk assessment, even after the products have reached market.

Typically, for product risk assessment, manufacturers primarily rely on reactive methods. A manufacturer thus typically monitors performance and quality of a product, manufactured by the manufacturer, through various quality events, such as consumer complaints about product malfunctions, quality control reports indicating deviations in production specifications, and regulatory notifications received from a regulatory body about potential quality concerns associated with the product. Pre-defined thresholds are often assigned to each type of quality event to identify when to trigger alerts. For example, a threshold might be set as ten consumer complaints about a specific quality concern within a month, or five quality control deviations of a particular type in a week, or one regulatory notification within a week. The frequency of the quality events is tracked and when the number of each type of quality event reaches or exceeds its corresponding threshold, an alert is generated and sent to a product quality control team. The product quality control team then reviews data associated with the quality events to assess the severity and potential impact of quality concerns indicated in the quality events, and decide on appropriate actions, which may include further investigation, product modifications, or in severe cases, consideration of a recall.

However, the reactive methods are largely dependent on accumulating a significant volume of data before potential issues can be detected and addressed. Thus, a quality concern in a product may be recognized only after receiving numerous complaints, deviations, or other quality events, thereby leading to a considerable delay between the emergence of the quality concern and detection of the quality concern through the reactive methods, especially for new products or rare but serious quality issues. The delay in detection of the quality concern can lead to increased safety risks for consumers as potentially hazardous products remain in use for extended periods. Moreover, the prolonged time delay often results in continued distribution of the product, increasing the likelihood of large-scale recalls when the quality concern is finally detected. Large-scale recalls of products that have already reached consumers can result in significant monetary losses that may encompass not only the direct costs associated with product retrieval and replacement but also potential legal liabilities arising from consumer harm. Further, the reputational damage caused by the large-scale recalls or delayed detection of quality concerns can lead to long-term erosion of consumer trust and brand value.

Moreover, with limited data availability for recently launched products, setting appropriate thresholds for different types of quality events becomes challenging. Consequently, manufacturers may struggle to proactively address problems specific to new products, potentially exposing consumers to unforeseen quality risks. The traditional reactive methods often focus on addressing immediate, known issues rather than anticipating and preventing future problems. Thus, there is a need for product risk assessment techniques that proactively identify quality concerns associated with products and facilitate proactive mitigation of the identified quality concerns.

The present subject matter describes approaches for proactive product risk assessment. The approach leverages forum data available on a plurality of public forums, such as social media platforms, industry-specific forums, product regulatory body databases, and data available over internet resources like websites, blogs, and news articles. The approach involves parsing the forum data to retrieve recall and feedback (RF) data corresponding to a target product that is to be assessed for identifying potential quality concerns in the target product. The RF data is analyzed to identify a plurality of analytical tools, such as a topic modelling tool, a trend analysis tool, and a sentiment analysis tool, to be implemented for assessing the target product and determine an assessment workflow indicating a sequential order of the plurality of analytical tools to be followed for assessing the target product. Tool-specific input data corresponding to each of the plurality of analytical tools may be generated and analyzed to obtain tool-specific output data from each of the plurality of analytical tools by implementing the plurality of analytical tools in accordance with the sequential order. Tool-specific output data obtained from the plurality of analytical tools is processed to identify probable quality concerns in the target product and generate an assessment report, including the probable quality concerns, corresponding to the target product. The present subject matter therefore integrates and analyses data from diverse public forums for comprehensive analysis of a quality of the target product to quickly detect any emerging quality concerns related to the target product before the emerging quality concerns cause serious damage, such as large-scale recall of the target product. Thus, the present subject matter facilitates proactive identification of quality concerns associated with the target product and facilitates proactive mitigation of the identified quality concerns.

In an example, each of the plurality of analytical tools may be configured to utilize a unique technique to comprehend corresponding input data and generate corresponding output data. In an example, for each first analytical tool in the sequential order of the plurality of analytical tools, the RF data may be processed to generate first tool-specific input data corresponding to the first analytical tool. The first tool-specific input data may be analyzed by implementing the first analytical tool to obtain first tool-specific output data from the first analytical tool. Further, for each subsequent analytical tool after the first analytical tool in the sequential order, the RF data and tool-specific output data obtained from one or more analytical tools preceding the subsequent analytical tool in the sequential order may be processed, to generate subsequent tool-specific input data corresponding to the subsequent analytical tool. The subsequent tool-specific input data may be analyzed by implementing the subsequent analytical tool to obtain subsequent tool-specific output data from the analytical tool.

In an example, for each public forum of the plurality of public forums, a corresponding pre-defined importance score assigned to the public forum may be obtained. The tool-specific input data corresponding to the analytical tool may be generated based on pre-defined importance scores assigned to the plurality of public forums.

In an example, the assessment report may be analyzed to ascertain whether the assessment report indicates any quality concern corresponding to the target product. Upon ascertaining the assessment report to indicate one or more quality concerns corresponding to the target product, a warning message may be generated for transmission to a user, to alert the user about the one or more quality concerns. The warning message may include the assessment report. In an example, one or more recommendations may be generated to mitigate the probable quality concerns in the target product. The one or more recommendations may be incorporated in the assessment report.

The present subject matter offers significant advantages in proactive risk assessment and management, particularly for new product releases. By leveraging data available on diverse public forums and employing a dynamic, multi-step analytical process, potential safety concerns and quality issues may be identified at an early stage. The capability to quickly detect the quality concerns is especially valuable for newly released products where historical quality event data, such as consumer complaints and notifications from regulatory bodies, may be limited or non-existent. The ability to analyze and integrate information from various public forums provides a comprehensive view of potential risks, allowing manufacturers to take pre-emptive actions and potentially avoid large-scale recalls. Additionally, the flexible and adaptive nature of the assessment workflow ensures a more relevant and effective risk assessment process across different industries and product types. By implementing the plurality of analytical tools with the tool-specific input data generated based on pre-defined importance scores assigned to the plurality of public forums, the present subject matter prioritizes data from more credible or influential sources, thereby enhancing the accuracy and efficiency of probable quality concerns identified in the target product.

The present subject matter generates customized assessment reports that provide the manufacturers with actionable insights specific to their target product, facilitating informed decision-making and enabling timely implementation of strategies for mitigating the quality concerns. The present subject matter promptly alerts users about probable quality concerns identified in the target product by providing the warning message, enabling swift action to address the probable quality concerns. By offering a proactive and data-driven method for risk assessment, the present subject matter enables the manufactures to maintain product quality, protect consumers from safety risks, and safeguard their reputation in the market. The sequential implementation of diverse analytical techniques allows for a nuanced and thorough examination of the RF data, with each analytical tool building upon the insights gained from previous analytical tool. The present invention thus addresses a critical gap in current product risk assessment practices, potentially leading to significant cost savings and enhanced consumer trust.

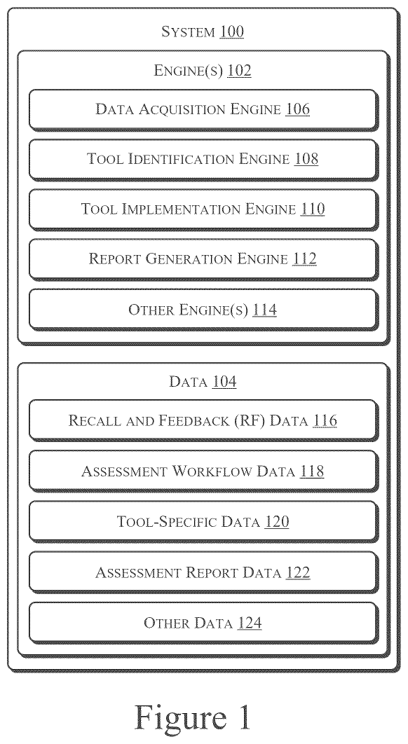

The present subject matter is further described with reference to FIG. 1 to FIG. 11. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for product risk assessment, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location. In an example, the system 100 may be utilized by users associated with an organization for detecting any emerging quality concerns related to products manufactured and distributed by the organization.

In one example, the system 100 may include engine(s) 102 and data 104. The system 100 may also include additional components, such as display, input/output interfaces, operating systems, applications, and other software or hardware components (not shown in the figures).

The engine(s) 102 may be implemented as a combination of hardware and programming, for example, programmable instructions to implement a variety of functionalities of the engine(s) 102. In examples described herein, such combinations of hardware and programming may be implemented in several different ways. For example, the engine(s) 102 may be programmed using executable instructions. Such instructions may be stored on a non-transitory machine-readable storage medium which may be coupled either directly with the system 100 or indirectly (for example, through networked means). In an example, the engine(s) 102 may include a processing resource, for example, either a single processor or a combination of multiple processors, to execute such instructions. In the present examples, the non-transitory machine-readable storage medium may store instructions that, when executed by the processing resource, implement the engine(s) 102. In other examples, the engine(s) 102 may be implemented as electronic circuitry.

In one example, the engine(s) 102 may include a data acquisition engine 106, a tool identification engine 108, a tool implementation engine 110, a report generation engine 112, and other engine(s) 114. The other engine(s) 114 may further implement functionalities that supplement functions performed by the system 100 or any of the engine(s) 102.

The data 104 includes data that is either received, stored, or generated as a result of functions implemented by any of the engine(s) 102 or the system 100. It may be further noted that information stored and available in the data 104 may be utilized by the engine(s) 102 for performing various functions of the system 100. The data 104 may include recall and feedback (RF) data 116, assessment workflow data 118, tool-specific data 120, assessment report data 122, and other data 124. The RF data 116 may include at least one of public feedback associated with products manufactured by the organization and historical recall information associated with other products that are recalled historically and are similar to the products manufactured by the organization. The assessment workflow data 118 may include assessment workflows generated by the system 100 to assess one or more of the products for identification of potential quality concerns. Each of the assessment workflows may include a sequential order in which various analytical tools are to be implemented for assessing a particular product from the products. In an example, the tool-specific data 120 may include tool description data describing various analytical tools available for implementation by the system 100 to assess the products for identification of potential quality concerns. In an example, the tool-specific data 120 may include input data generated by the system 100 for using as an input for a particular analytical tool of the various analytical tools and output data obtained from the particular analytical tool by implementing the particular analytical tool with the input data as the input. The assessment report data 122 may include data related to assessment reports generated by the system 100. The other data 124 may include data that is either received, stored, or generated as a result of functions implemented by any of the engine(s) 102.

In operation, for assessing risk associated with a target product, the data acquisition engine 106 may parse forum data available on a plurality of public forums to retrieve recall and feedback (RF) data corresponding to the target product to be assessed for identifying potential quality concerns in the target product. In one example; the target product may be from any industry, including, but not limited to, a pharmaceutical product, such as a medicine and a medical device, such as a heat monitoring device and a blood glucose monitoring system; an electronic device, such as a wearable fitness tracker and a laptop; an automative, such as a car; an automotive product, such as a clutch; a consumer product, such as a vacuum cleaner and a geyser; and home appliance and automation devices, such as a smart home thermostat and a refrigerator. The plurality of public forums may include any publicly accessible online platforms or digital spaces where information, opinions, experiences, and discussions can be shared about the products, including the target product, manufactured and distributed by the organization. Examples of the plurality of public forums may include, but are not limited to, social media platforms, online review websites, discussion boards, industry-specific forums, product regulatory body databases like food and drug administration (FDA) database, blogs, consumer complaint websites, and product-specific community forums. Thus, the forum data may include information, such as user posts, comments, reviews, ratings, and other forms of user-generated content, available on the plurality of public forums.

In addition to information that is relevant for assessment of the target product, the forum data may include information that is irrelevant for the assessment of the target product. Thus, the forum data may be parsed to retrieve the RF data corresponding to the target product. The RF data may be a subset of the forum data and may include information that is relevant for assessment of the target product. For instance, the RF data may include at least one of public feedback data associated with the target product and historical recall data associated with one or more products having at least one similarity with the target product. The at least one similarity may include similarity in composition, manufacturing process, and/or usage of the one or more products with the target product. The public feedback data may include opinions, comments, reviews, ratings, and discussions of various users about the target product. The historical recall data may encompass the description of investigations carried out and findings documented during historical recalls associated with the one or more products. For example, the historical recall data may include data, such as recall reason, product type, and product description, obtained from an FDA database or a similar database in relation to historical recalls associated with the one or more products. In an example, the RF data may be a processed form of the subset of the forum data that is relevant for assessment of the target product. In one example, the RF data may be stored within the RF data 116.

Once the RF data is retrieved, the tool identification engine 108 may analyze the RF data to generate an assessment workflow to be followed for assessing the target product. The assessment workflow may include a sequential order of a plurality of analytical tools to be implemented for assessing the target product. Each of the plurality of analytical tools may be configured to utilize a unique technique to comprehend corresponding input data and generate corresponding output data. In an example, each of the plurality of analytical tools may be module(s) designed to process and analyze the corresponding input data according to the unique technique to generate the corresponding output data. The plurality of analytical tools may include a data mining tool, a natural language processing tool, a sentiment analysis tool, a topic modelling tool, a trend analysis tool, a statistical analysis tool, and any other customized tool, such as a customized machine learning tool, specifically configured to process and analyze the RF data in a pre-configured manner.

In an example, for generating the assessment workflow, the tool identification engine 108 may classify the RF data into distinct categories and determine the proportion of each of the distinct categories based on the analysis of the RF data. The assessment workflow may be generated based on the distinct categories and the proportion of each of the distinct categories. For instance, upon determining that the RF data contains 60% textual customer reviews, 30% numerical ratings, and 10% image-based feedback about the target product, text analysis tools may be prioritized in the assessment workflow, followed by statistical analysis tools and image processing tools. In another instance, upon determining that the RF data comprises 30% historical recall data from the FDA database, 50% customer reviews from e-commerce platforms, and 20% social media mentions, the assessment workflow may prioritize analytical tools specialized for analysis of the historical recall data, followed by sentiment analysis tools for analysis of the customer reviews, and finally trend analysis tools to process the social media mentions.

In an example, the assessment workflow may be generated based on factors such as reliability of each of the plurality of public forums from which the RF data is retrieved, the distinct categories and the proportion of each of the distinct categories, computational resource requirements, and the potential impact of each distinct category on identification of the potential quality concerns. The assessment workflow may also consider the sequential dependencies between the plurality of analytical tools, prioritizing analysis that provide foundational insights for subsequent analyses using the plurality of analytical tools. Thus, the generated assessment workflow may include a strategically sequenced combination of the plurality of analytical tools such that available data, i.e., the RF data, corresponding to the target product may be efficiently analysed using the plurality of analytical tools for identification of potential quality concerns in the target product. In one example, the assessment workflow may be stored within the assessment workflow data 118.

Once the assessment workflow is generated, the tool implementation engine 110 may process the RF data to generate tool-specific input data corresponding to each analytical tool of the plurality of analytical tools. The tool-specific input data corresponding to a particular analytical tool, of the plurality of analytical tools, may be data that has been processed, formatted, and structured to meet the specific requirements and constraints of the particular analytical tool, ensuring each of the plurality of analytical tools performs its specialized function effectively within the assessment workflow. In one example, the tool-specific input data may be stored within the tool-specific data 120.

In an example, for generating the tool-specific input data for the analytical tool, the tool implementation engine 110 may process tool description data corresponding to the analytical tool along with the RF data to determine most appropriate data format and content to be used within the tool-specific input data. The tool description data may include specifications of the analytical tool, input data constraints associated with the analytical tool, and processing capabilities of the analytical tool. For example, for a sentiment analysis tool, tool-specific input data may be generated to include cleaned and standardized text from customer reviews, with content filtered for relevant aspects such as accuracy, battery life, and Bluetooth functionality of the target product, such as the heat monitoring device. Further, for a topic modelling tool, tool-specific input data may be generated to include a corpus of individual feedback documents with stop words removed and words lemmatized, and content filtered for product-specific terminologies. In one example, the tool description data may be stored within the tool-specific data 120.

For each analytical tool of the plurality of analytical tools, the tool implementation engine 110 may analyze the tool-specific input data by implementing the analytical tool in accordance with the sequential order to obtain tool-specific output data from the analytical tool. The tool-specific output data obtained from the analytical tool may indicate results, insights, or processed information generated by the analytical tool after analyzing the tool-specific input data. For example, the tool-specific output data obtained from the sentiment analysis tool may indicate overall sentiment distribution corresponding to one or more features of the target product. For instance, for a wearable fitness tracker as a target product, the tool-specific output data obtained from the sentiment analysis tool may indicate 60% positive sentiment related to design features of the wearable fitness tracker, 30% negative sentiment focused on syncing issues associated with the wearable fitness tracker, and 10% neutral sentiment. Further, the tool-specific output data obtained from the topic modelling tool may indicate list of key topics discussed in the RF data along with associated keywords found in the RF data. For instance, for a wearable fitness tracker as a target product, the tool-specific output data obtained from the topic modelling tool may indicate topics such as “Bluetooth connectivity issues” with keywords (pairing, disconnect, and range), “Battery life concerns” with keywords (short, drain, charging), and “Audio quality problems” with keywords (static, muffled, bass). In one example, the tool-specific output data may be stored within the tool-specific data 120.

The report generation engine 112 may process tool-specific output data obtained from the plurality of analytical tools to identify probable quality concerns in the target product. The probable quality concerns may be defined as potential issues or defects in the target product that are likely to affect the performance, safety, or user satisfaction associated with the target product. The probable quality concerns may have a significant likelihood of being genuine problems that may require attention or intervention to prevent large-scale recall of the target product. For example, for a heat monitoring device, a probable quality concern may be inconsistent temperature readings at high temperatures. The probable quality concern in the heat monitoring device may be identified through analysis of user reviews reporting discrepancies in the temperature readings, coupled with an increasing trend in complaints related to inaccurate temperature readings for the one or more products that have at least one similarity with the target product and a high risk score associated with temperature accuracy issues.

Further, the report generation engine 112 may process tool-specific output data obtained from the plurality of analytical tools to generate an assessment report, including the probable quality concerns, corresponding to the target product. The assessment report may be a comprehensive document that summarizes findings, analysis, and recommendations resulting from a systematic evaluation of quality, performance, and potential risks associated with the target product, by implementing the plurality of analytical tools in accordance with the assessment workflow. The assessment report may include data-driven insights, the potential quality concerns, severity and trends of the potential quality concerns, historical context associated with the potential quality concerns, and suggested actions for addressing the potential quality concerns. For example, an assessment report for a heat monitoring device may include sections on overall sentiment analysis (e.g., 55% positive reviews), the potential quality concerns (e.g., temperature accuracy, battery life, mobile application connectivity), risk scores for each of the potential quality concerns, trend analysis showing a 40% increase in temperature accuracy related recalls or complaints, and recommendations such as urgent investigation into temperature sensor calibration and firmware updates for battery optimization. Thus, the present subject matter facilitates proactive identification of quality concerns associated with the target product and facilitates proactive mitigation of the identified quality concerns.

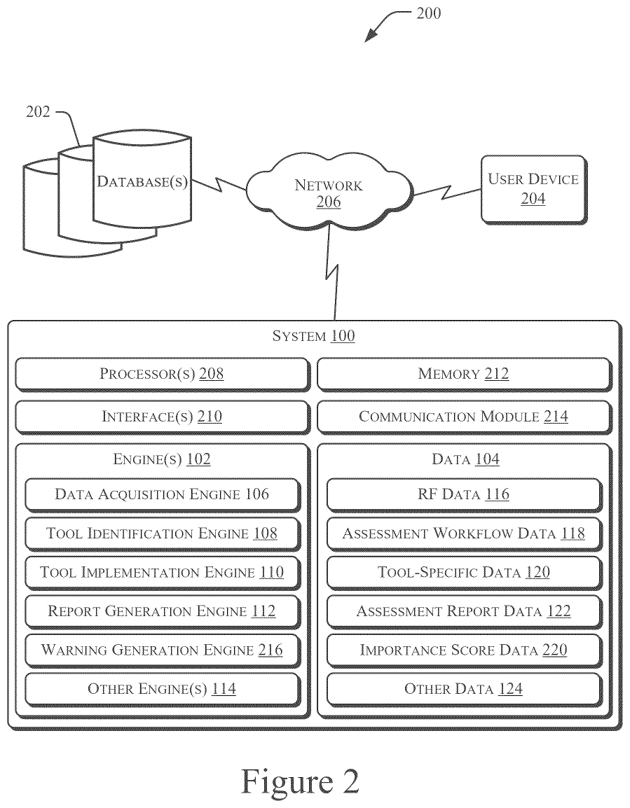

FIG. 2 illustrates a computing environment 200 implementing the system 100 for product risk assessment, according to another example. In one example, the computing environment 200 may include the system 100, database(s) 202, and a user device 204. The database(s) 202 may be individually referred to as database 202 and collectively referred to as the databases 202. The database 202 may have the capabilities to store data in structured or unstructured formats. The database 202 may serve as a data repository for storing and managing forum data associated with a plurality of public forums. The plurality of public forums may include any publicly accessible online platforms or digital spaces where information, opinions, experiences, and discussions can be shared about the products, including the target product, manufactured and distributed by the organization. Examples of the plurality of public forums may include, but are not limited to, social media platforms, online review websites, discussion boards, industry-specific forums, product regulatory body databases like food and drug administration (FDA) database, blogs, consumer complaint websites, and product-specific community forums. Thus, the database 202 may store the forum data that may include information, such as user posts, comments, reviews, ratings, and other forms of user-generated content, available on the plurality of public forums. In an example, the database 202 may be a distributed computing system having one or more physical computing systems geographically distributed at same or different locations. In another example, one or more components of the database 202 may be hosted virtually, for example, on a cloud-based platform, while other components may be geographically distributed at same or different locations. In yet another example, the database 202 may be a stand-alone physical system geographically located at a particular location.

In an example, the user device 204 may be any electronic device that allows a user to access, view, and interact with digital information or applications. In an example, the user device 204 may be a device utilized by a user to view assessment reports or receive warning messages generated by the system 100 after assessing a target product for identification of potential quality concerns in the target product. In an example, the user device 204 may be utilized by the user to trigger the system 100 to initiate assessment of the target product for identification of potential quality concerns in the target product. Examples of the user device 204 may include, but are not limited to, a smartphone, a laptop, a mobile phone, and a computer. Examples of the user device 204 may also include, but are not limited to, a desktop, a tablet computer, a wearable electronic device, a personal digital assistant (PDA), and any electronic device capable of transmitting or receiving data.

The system 100, the databases 202, and the user device 204 may be communicably coupled with each other over a communication network 206 and may exchange data and signals over the communication network 206. The communication network 206 may be a wireless network, a wired network, or a combination thereof. The communication network 206 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 206 may include various network entities, such as transceivers, gateways, and routers. In an example, the communication network 206 may include any communication network that uses any of the commonly used protocols, for example, Hypertext Transfer Protocol (HTTP), and Transmission Control Protocol/Internet Protocol (TCP/IP).

In one example, the system 100 may include processor(s) 208, interface(s) 210, memory 212, a communication module 214, the engine(s) 102, and the data 104. The system 100 may also include other components, such as display, input/output interfaces, operating systems, applications, and other software or hardware components (not shown in the figures).

The processor(s) 208 may be implemented as microprocessors, microcomputers, microcontrollers, digital signal processors, central processing units, state machines, logic circuitries, and/or other devices that manipulate signals based on operational instructions. The interface(s) 210 may allow the connection or coupling of the system 100 with one or more other devices, such as the databases 202 and the user device 204, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory 212 may be a computer-readable medium, examples of which include volatile memory (e.g., RAM), and/or non-volatile memory (e.g., Erasable Programmable read-only memory, i.e., EPROM, flash memory, etc.). The memory 212 may be an external memory or an internal memory, such as a flash drive, a compact disk drive, an external hard disk drive, or the like. The memory 212 may further include the data 104 and/or other data which may either be received, utilized, or generated during the operation of the system 100.

The communication module 214 may be a wireless communication module. Examples of the communication module 214 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 214 may also include one or more antennas to enable wireless transmission and reception of data and signals. The communication module 214 may allow the system 100 to transmit data and signals to one or more other devices, such as the databases 202 and the user device 204; and receive data and signals from the one or more other devices.

The engine(s) 102 may include the data acquisition engine 106, the tool identification engine 108, the tool implementation engine 110, the report generation engine 112, and the other engine(s) 114, as explained with reference to FIG. 1. The engine(s) 102 may further include a warning generation engine 216. In an example, the system 100 may be configured to implement an artificial intelligence/machine learning (AI/ML) model, such as a large language model (LLM), for performing the function of any of the engine(s) 102. The AI/ML model may be fed with pre-defined instructions that may enable the AI/ML model to act as an intelligent orchestrator for implementing the functions of any of the engine(s) 102.

The data 104 may include the RF data 116, the assessment workflow data 118, the tool-specific data 120, the assessment report data 122, and the other data 124, as explained with reference to FIG. 1. In an example, the data 104 may further include importance score data 220. The importance score data 220 may include pre-defined importance scores assigned to the plurality of public forums. The pre-defined importance scores may reflect relative significance, credibility, or impact of the plurality of public forums for assessment of various products manufactured by an organization.

In operation, a user associated with an organization, intending to assess a target product manufactured by the organization for identifying potential quality concerns in the target product, may issue a risk assessment request in relation to the target product using the user device 204. In an example, the risk assessment request issued by the user may specify at least one of a unique identifier representing the target product and a description of the target product. In one example; the target product may be from any industry, including, but not limited to, a pharmaceutical product, such as a medicine and a medical device, such as a heat monitoring device and a blood glucose monitoring system; an electronic device, such as a wearable fitness tracker and a laptop; an automative, such as a car; an automotive product, such as a clutch; a consumer product, such as a vacuum cleaner and a geyser; and home appliance and automation devices, such as a smart home thermostat and a refrigerator. Upon receiving the risk assessment request, the data acquisition engine 106 may parse forum data available on the plurality of public forums to retrieve recall and feedback (RF) data corresponding to the target product to be assessed for identifying potential quality concerns in the target product. The forum data may include information, such as user posts, comments, reviews, ratings, and other forms of user-generated content, available on the plurality of public forums. In an example, the data acquisition engine 106 may implement the AI/ML model, such as the LLM, for parsing the forum data to retrieve the RF data corresponding to the target product. In an example, the forum data may be accessed from the databases 202.

In addition to information that is relevant for assessment of the target product, the forum data may include information that is irrelevant for the assessment of the target product. For example, the forum data may include information corresponding to products and discussion which are unrelated to the target product directly and indirectly. Thus, the forum data may be parsed to retrieve the RF data corresponding to the target product. The RF data may be a subset of the forum data and may include information that is relevant for assessment of the target product. For instance, the RF data may include at least one of public feedback data associated with the target product and historical recall data associated with one or more products having at least one similarity with the target product. The at least one similarity may include similarity in composition, manufacturing process, and/or usage of the one or more products with the target product. The public feedback data may include opinions, comments, reviews, ratings, and discussions of various users about the target product. The historical recall data may encompass the description of investigations carried out and findings documented during historical recalls associated with the one or more products. For example, the historical recall data may include data, such as recall reason, product type, and product description, obtained from an FDA database or a similar database in relation to historical recalls associated with the one or more products. In an example, the RF data may be a processed form of the subset of the forum data that is relevant for assessment of the target product. In one example, the RF data may be stored within the RF data 116.

Once the RF data is retrieved, the tool identification engine 108 may analyze the RF data to identify a plurality of analytical tools to be implemented for assessing the target product and determine a sequential order of the plurality of analytical tools to be followed for assessing the target product. The sequential order of the plurality of analytical tools may be included in an assessment workflow that is to be followed for assessing the target product. In an example, the tool identification engine 108 may implement the AI/ML model, such as the LLM, for analyzing the RF data to identify the plurality of analytical tools and the sequential order of the plurality of analytical tools. Each of the plurality of analytical tools may be configured to utilize a unique technique to comprehend corresponding input data and generate corresponding output data. In an example, each of the plurality of analytical tools may be module(s) designed to process and analyze the corresponding input data according to the unique technique to generate the corresponding output data. The plurality of analytical tools may include a data mining tool, a natural language processing tool, a sentiment analysis tool, a topic modelling tool, a trend analysis tool, a statistical analysis tool, and any other customized tool, such as a customized machine learning tool, specifically configured to process and analyze the RF data in a pre-configured manner.

In an example, for identifying the plurality of analytical tools and determining the sequential order of the plurality of analytical tools, the tool identification engine 108 may classify the RF data into distinct categories and determine the proportion of each of the distinct categories based on the analysis of the RF data. The plurality of analytical tools may be identified and the sequential order of the plurality of analytical tools may be determined based on the distinct categories and the proportion of each of the distinct categories. For instance, upon determining that the RF data contains 60% textual customer reviews, 30% numerical ratings, and 10% image-based feedback about the target product, a text analysis tool, a statistical analysis tool, and an image processing tool may be selected, from various analytical tools available to the system 100, for implementing during assessment of the target product. Further, in the sequential order, the text analysis tool may be prioritized, followed by the statistical analysis tool and the image processing tool. In another instance, upon determining that the RF data comprises 30% historical recall data from the FDA database, 50% customer reviews from e-commerce platforms, and 20% social media mentions, an analytical tools specialized for analysis of the historical recall data, a sentiment analysis tool, and a trend analysis tool may be selected, from various analytical tools available to the system 100, for implementing during assessment of the target product. Further, in the sequential order, the analytical tool specialized for analysis of the historical recall data may be prioritized, followed by the sentiment analysis tool for analysis of the customer reviews, and finally the trend analysis tool to process the social media mentions.

In an example, the sequential order may be a linear sequence of the plurality of analytical tools, according to which one analytical tool, of the plurality of analytical tools, is implemented at a time and output of that analytical tool is processed before implementing any subsequent analytical tool in the sequential order. In another example, the sequential order may be a non-linear sequence of the plurality of analytical tools, according to which multiple analytical tools, of the plurality of analytical tools, may be simultaneously implemented at a time, and output of the multiple analytical tools may be processed before implementing any subsequent analytical tool(s) in the sequential order. For example, according to an example sequential order, the sentiment analysis tool and the trend analysis tool may be implemented simultaneously, followed by the topic modelling tool, and then followed by simultaneous implementation of the natural language processing tool and the statistical analysis tool.

In an example, the plurality of analytical tools may be identified and the sequential order of the plurality of analytical tools may be determined based on factors such as reliability of each of the plurality of public forums from which the RF data is retrieved, the distinct categories and the proportion of each of the distinct categories, computational resource requirements, and the potential impact of each distinct category on identification of the potential quality concerns. The sequential order may also consider the sequential dependencies between the plurality of analytical tools, prioritizing analysis that provide foundational insights for subsequent analyses using the plurality of analytical tools. Thus, the determined sequential order may provide a strategically sequenced combination of the plurality of analytical tools such that available data, i.e., the RF data, corresponding to the target product may be efficiently analysed using the plurality of analytical tools for identification of potential quality concerns in the target product. In one example, the sequential order of the plurality of analytical tools may be stored within the assessment workflow data 118.

The tool implementation engine 110 may process the RF data to generate first tool-specific input data corresponding to each first analytical tool in the sequential order of the plurality of analytical tools. In an example, the tool implementation engine 110 may implement the AI/ML model, such as the LLM, for processing the RF data to generate the first tool-specific input data. The first tool-specific input data corresponding to the first analytical tool may be data that has been processed, formatted, and structured to meet the specific requirements and constraints of the particular analytical tool, ensuring the first analytical tool performs its specialized function effectively. In one example, the first tool-specific input data may be stored within the tool-specific data 120.

In an example, for generating the first tool-specific input data, the tool implementation engine 110 may process tool description data corresponding to the first analytical tool along with the RF data to determine most appropriate data format and content to be used within the first tool-specific input data. The tool description data may include specifications of the first analytical tool, input data constraints associated with the first analytical tool, and processing capabilities of the first analytical tool. For example, if the first analytical tool is determined as a sentiment analysis tool, first tool-specific input data may be generated to include cleaned and standardized text from customer reviews, with content filtered for relevant aspects such as accuracy, battery life, and Bluetooth functionality of the target product, such as the heat monitoring device. Further, if the first analytical tool is determined as a topic modelling tool, first tool-specific input data may be generated to include a corpus of individual feedback documents with stop words removed and words lemmatized, and content filtered for product-specific terminologies. In one example, the tool description data may be stored within the tool-specific data 120.

For each first analytical tool of the plurality of analytical tools, the tool implementation engine 110 may analyze the first tool-specific input data by implementing the first analytical tool to obtain first tool-specific output data from the first analytical tool. In an example, the tool implementation engine 110 may implement the AI/ML model, such as the LLM, for providing the first tool-specific input data to the first analytical tool and obtaining the first tool-specific output data from the first analytical tool. The first tool-specific output data obtained from the first analytical tool may indicate results, insights, or processed information generated by the first analytical tool after analyzing the first tool-specific input data. For example, if the first analytical tool is determined as a sentiment analysis tool, the sentiment analysis tool may analyze the first tool-specific input data, such as 10,000 customer reviews from various sources including e-commerce platforms, social media, and industry forums. Based on analysis of the first tool-specific input data, the sentiment analysis tool may generate the first tool-specific output data that classifies the customer reviews as 55% positive reviews, 35% negative reviews, and 10% neutral reviews, thereby identifying 3,500 negative reviews which may be utilized for further analysis by the system 100.

For each subsequent analytical tool after the first analytical tool in the sequential order, the tool implementation engine 110 may process the RF data and tool-specific output data obtained from one or more analytical tools preceding the subsequent analytical tool in the sequential order, to generate subsequent tool-specific input data corresponding to the subsequent analytical tool. In an example, the tool implementation engine 110 may implement the AI/ML model, such as the LLM, for processing the RF data and the tool-specific output data obtained from the one or more analytical tools to generate the subsequent tool-specific input data. The subsequent tool-specific input data corresponding to the subsequent analytical tool may be data that has been processed, formatted, and structured to meet the specific requirements and constraints of the subsequent analytical tool, ensuring the subsequent analytical tool performs its specialized function effectively. In one example, the subsequent tool-specific input data may be stored within the tool-specific data 120.

In an example, for generating the subsequent tool-specific input data, the tool implementation engine 110 may process tool description data corresponding to the subsequent analytical tool along with the RF data and the tool-specific output data obtained from the one or more analytical tools to determine most appropriate data format and content to be used within the subsequent tool-specific input data. The tool description data may include specifications of the subsequent analytical tool, input data constraints associated with the subsequent analytical tool, and processing capabilities of the subsequent analytical tool. For example, if the first analytical tool is determined as the sentiment analysis tool and the subsequent analytical tool is determined as the topic modelling tool, the subsequent tool-specific input data may be generated by processing the RF data and the first tool-specific output data from the sentiment analysis tool. For example, the subsequent tool-specific input data may include the 3,500 negative reviews identified by the sentiment analysis tool. In one example, the tool description data may be stored within the tool-specific data 120.

For each subsequent analytical tool after the first analytical tool in the sequential order, the tool implementation engine 110 may analyze the subsequent tool-specific input data by implementing the subsequent analytical tool to obtain subsequent tool-specific output data from the analytical tool. The subsequent tool-specific output data obtained from the subsequent analytical tool may indicate results, insights, or processed information generated by the subsequent analytical tool after analyzing the subsequent tool-specific input data. For example, the subsequent tool-specific output data may be obtained from the topic modelling tool by processing the 3,500 negative reviews. The subsequent tool-specific output data obtained from the topic modelling tool may indicate three primary topics including temperature accuracy, battery life, and mobile application connectivity issues associated with the heat monitoring device. For the temperature accuracy issue, the subsequent tool-specific output data obtained from the topic modelling tool may indicate frequently appearing keywords such as “inconsistent”, “drift”, and “calibration”. For the battery life issue, the subsequent tool-specific output data obtained from the topic modelling tool may indicate frequently appearing keywords such as “short duration”, “frequent charging”, and “unexpected shutdowns”. For the mobile application connectivity issue, the subsequent tool-specific output data obtained from the topic modelling tool may indicate frequently appearing keywords such as “disconnects”, “sync failures”, and “data loss”.

The RF data, the first tool-specific output data obtained from the sentiment analysis tool, and the subsequent tool-specific output data obtained from the topic modelling tool may be processed to generate subsequent tool-specific input data corresponding to any other subsequent analytical tool. For example, the RF data, the first tool-specific output data obtained from the sentiment analysis tool, and the subsequent tool-specific output data may be processed to generate subsequent tool-specific input data corresponding to a risk score analysis tool. The risk score analysis tool may be implemented to analyze the subsequent tool-specific input data specifically generated corresponding to the risk score analysis tool by the tool implementation engine 110. Subsequent tool-specific output data obtained from the risk score analysis tool may indicate risk scores assigned to each of the three primary topics by the risk score analysis tool. For example, based on analysis of the subsequent tool-specific input data corresponding to the risk score analysis tool, the temperature accuracy issue may be assigned a risk score of 8.5 out of 10, the battery life issue may be assigned a risk score of 7.2 out of 10, and the mobile application connectivity issue is assigned a risk score of 6.8 out of 10, reflecting importance of addressing each corresponding primary topic before the corresponding primary topic causes any adverse damage, such as large-scale recalls or consumer safety-concerning accident. In another example, the subsequent tool-specific output data obtained from the risk score analysis tool may indicate risk score for various pre-defined risk indicators corresponding to each of the primary topics identified in the target product. Example of the various pre-defined risk indicators may include, but are not limited to, reputation risks, legal and liability risks, adverse events, performance issues, supply chain risks, product recalls, customer complaints, regulatory violations, quality defects, and safety concerns associated with the target product.

The RF data, the first tool-specific output data obtained from the sentiment analysis tool, and the subsequent tool-specific output data obtained from the topic modelling tool and the risk score analysis tool may be processed to generate subsequent tool-specific input data corresponding to any other subsequent analytical tool. For example, the first tool-specific output data obtained from the sentiment analysis tool and the subsequent tool-specific output data may be processed to generate subsequent tool-specific input data corresponding to a trend analysis tool. The trend analysis tool may be implemented to analyze the subsequent tool-specific input data specifically generated corresponding to the trend analysis tool by the tool implementation engine 110. Subsequent tool-specific output data obtained from the trend analysis tool may indicate trends and patterns identified by the trend analysis tool in the subsequent tool-specific input data. For example, based on analysis of the subsequent tool-specific input data, such as negative reviews over past three months, corresponding to the trend analysis tool, a sharp 40% increase in negative reviews related to the temperature accuracy issue may be identified over past two weeks, potentially indicating a recent quality control issue or a recent software update issue. Further, a steady 10% rise in negative reviews related to the battery life issue may be identified, indicating that the battery issue is a persistent and growing problem. Further, negative reviews related to the mobile application connectivity issue may be identified to be fluctuating without a clear trend, possibly reflecting intermittent problems or varying user experiences.

In another example, based on analysis of the subsequent tool-specific input data, such as the historical recall data associated with the primary topics identified by the topic modelling tool, the subsequent tool-specific output data obtained from the trend analysis tool may uncover one historical recall for a similar temperature accuracy issue in one of the one or more products, that have at least one similarity with the target product, two years ago. The historical recall may be analyzed to identify that the historical recall occurred due to faulty sensors which led to overheating risks. Further, the subsequent tool-specific output data obtained from the trend analysis tool may indicate that the battery life issue and the mobile application connectivity issue have not resulted in recalls historically, indicating that the battery life issue and the mobile application connectivity issue are less likely to trigger recalls unless safety is directly impacted by the battery life and the mobile application connectivity issues.

Although an exemplary sequential order of the sentiment analysis tool, the topic modelling tool, the risk score analysis tool, and the trend analysis tool has been described, the exemplary sequence order is not intended to be construed as a limitation, and the sentiment analysis tool, the topic modelling tool, the risk score analysis tool, the trend analysis tool, and any other analytical tools may be implemented in a different sequential order to implement the functionalities of the system 100.

In an example, for each public forum of the plurality of public forums, the tool implementation engine 110 may obtain a corresponding pre-defined importance score assigned to the public forum. In an example, the corresponding pre-defined importance score may be a pre-defined numerical value assigned to the public forum. The corresponding pre-defined importance score may reflect relative significance, credibility, or impact of the public forum in the context of risk assessment of the target product. For example, a popular consumer electronics review website may be one of the plurality of public forums that is assigned an importance score of 0.9 on a scale of 0 to 1, indicating high reliability and relevance of the popular consumer electronics review website. Further, a general social media platform may be one of the plurality of public forums that is assigned an importance score of 0.6, reflecting moderate relevance but potentially lower reliability of the general social media platform. Further, a niche forum dedicated to a specific category, to which the target product belong, may be one of the plurality of public forums that is assigned an importance score of 0.8, due to focused and potentially expert user base of the niche forum dedicated to the specific category. Furthermore, a review section of an e-commerce platform may be one of the plurality of public forums that is assigned an importance score of 0.7, balancing the wide reach of the e-commerce platform with potential biases in customer reviews. Moreover, an FDA database or any other similar database may be one of the plurality of public forums that is assigned an importance score of 0.95, indicating high credibility of the FDA database for being an official source.

In an example, the corresponding pre-defined importance score may be pre-assigned to the public forum by a user, such as a subject matter expert (SME) having knowledge of the plurality of public forums or a user associated with the organization by which the target product is manufactured, or may be pre-generated by the system 100. For instance, the SME may assign the corresponding pre-defined importance score based on their knowledge of reliability and relevance of the plurality of public forums. In another instance, the corresponding pre-defined importance score may be assigned by conducting surveys among target users to understand which public forums are trusted and relied on for information of the target product. In yet another instance, the system 100 may generate the corresponding pre-defined importance score based on analysis of historical performance information indicating how accurately different public forums have predicted or identified quality concerns in the past. In yet another instance, the system 100 may generate the corresponding pre-defined importance score based on analysis, utilizing machine learning techniques, of the correlation between data from different public forums and actual product quality concerns. In an example, the system 100 may adjust the corresponding pre-defined importance score over time based on the accuracy and timeliness of information from each of the plurality of public forums. In an example, the corresponding pre-defined importance score may be obtained directly from the user. In another example, the corresponding pre-defined importance score may be pre-stored in the memory 212 and may be obtained from the memory. In one example, the corresponding pre-defined importance score may be stored within the importance score data 220.

The tool implementation engine 110 may generate the tool-specific input data corresponding to the analytical tool based on pre-defined importance scores assigned to the plurality of public forums. Thus, pre-defined importance scores assigned to the plurality of public forums may be used to weigh the contribution of data from different public forums when generating the tool-specific input data for each of the plurality of analytical tools. For example, while generating the tool-specific input data corresponding to the trend analysis tool, information available on the FDA database regarding a particular issue, such as the temperature accuracy issue, may be given more weightage than information available on the general social media platform regarding the particular issue.

In an example, the plurality of analytical tools may include at least the topic modelling tool. For generating tool-specific input data corresponding to the topic modelling tool, the tool implementation engine 110 may process at least the RF data to determine relevant data including one or more negative feedbacks about the target product. In an example, tool-specific output data obtained from one or more analytical tools preceding the topic modelling tool in the sequential order may be processed along with the RF data to determine the relevant data. Each of the one or more negative feedbacks may indicate at least one quality concern in the target product. In an example, the one or more negative feedbacks about the target product may include critical, unfavourable, or dissatisfied comments, reviews, or reports from users, customers, or stakeholders that highlight issues, shortcomings, or problems with performance, quality, safety, or user experience of the target product. For example, for a heat monitoring device as a target product, the one or more negative feedbacks may include a first negative feedback “The temperature readings are consistently off by 5-10 degrees, making it unreliable for precise monitoring in our factory”, a second negative feedback “Battery life is much shorter than advertised. It barely lasts a full shift, which is unacceptable for continuous monitoring”, a third negative feedback “The mobile app keeps crashing when I try to sync data, causing us to lose critical temperature logs”, a fourth negative feedback “Device stopped working after exposure to high humidity, despite being marketed as suitable for industrial environments”, a fifth negative feedback “Alarm function failed to trigger when temperatures exceeded the set threshold, posing a serious safety risk in our facility”, and other similar negative feedbacks.

The tool implementation engine 110 may generate tool-specific input data corresponding to the topic modelling tool using the relevant data. In an example, the relevant data may be pre-processed using various pre-processing techniques, such as data cleaning, formatting, feature extraction, and normalization, to generate the tool-specific input data corresponding to the topic modelling tool. Tool-specific output data obtained from the topic modelling tool based on analysis of the tool-specific input data may indicate one or more key quality concerns discussed in the negative feedbacks. The one or more key concerns may include primary issues related to quality, performance, or safety of the target product that emerge as distinct themes or topics. The one or more key concerns may be extracted and grouped by the topic modelling tool based on the frequency and co-occurrence of specific words or phrases in the negative feedbacks.

For example, the tool-specific output data obtained from the topic modelling tool based on analysis of negative feedbacks about a heat monitoring device may indicate three key quality concerns including temperature accuracy, battery life, and mobile application connectivity issues associated with the heat monitoring device. The temperature accuracy issue may be determined based on identification of a cluster of keywords, such as “inaccurate”, “inconsistent”, “deviation”, “drift”, and “calibration”, frequently appearing in the negative feedbacks, indicating a key concern about the ability of the heat monitoring device to provide precise temperature readings. Further, the battery life issue may be determined based on identification of a cluster of keywords, such as “short duration”, “dies quickly”, “power issues”, “frequent charging”, and “unexpected shutdowns”, frequently appearing in the negative feedbacks, highlighting a key concern about the power management and longevity during use of the heat monitoring device. Furthermore, the mobile application connectivity issue may be determined based on identification of a cluster of keywords, such as “disconnects”, “app crashes”, “sync failures”, “connectivity issues”, and “data loss” frequently appearing in the negative feedbacks, indicating a key concern about the reliability of accompanying software or mobile application of the heat monitoring device.

In an example, the plurality of analytical tools may include at least the sentiment analysis tool. For generating tool-specific input data corresponding to the sentiment analysis tool, the tool implementation engine 110 may process at least the RF data to determine relevant data including customer feedbacks about the target product. In an example, tool-specific output data obtained from one or more analytical tools preceding the sentiment analysis tool in the sequential order may be processed along with the RF data to determine the relevant data. Each of the one or more negative feedbacks may indicate at least one quality concern in the target product. In an example, customer feedbacks about the target product may include opinions, comments, reviews, ratings, and experiences shared by users or consumers about the target product. The customer feedbacks can be positive, negative, or neutral, and may cover various aspects of the target product including the performance, quality, usability, and overall satisfaction of the target product. For example, for a heat monitoring device as a target product, the customer feedbacks may include a first customer feedback “The device is okay, but the battery life could be better. I find myself charging it more often than I would like”, a second customer feedback “I am pleased with this device. It performs well, has good battery life, and the app is user-friendly. It meets our needs effectively”, a third customer feedback “While the accuracy of the device is excellent, the short battery life is a significant drawback. It's a mix of great features and frustrating limitations”, a fourth customer feedback “This is the worst product I have ever purchased. It is completely unreliable, the customer service is terrible, and it is a waste of money. I strongly advise against buying it”, a fifth customer feedback “The heat monitor works as expected. It is neither exceptional nor disappointing. It does the job it is supposed to do”, a sixth customer feedback “This heat monitor is absolutely fantastic! It is incredibly accurate, easy to use, and has revolutionized our temperature management process. Best purchase we've made for our facility”, a seventh customer feedback “I am not satisfied with this heat monitor. The readings are inconsistent, and the app frequently crashes. It is causing more problems than it solves”, and other similar customer feedbacks.

The tool implementation engine 110 may generate tool-specific input data corresponding to the sentiment analysis tool using the relevant data. In an example, the relevant data may be pre-processed using various pre-processing techniques, such as data cleaning, formatting, feature extraction, and normalization, to generate the tool-specific input data corresponding to the sentiment analysis tool. Tool-specific output data obtained from the sentiment analysis tool based on analysis of the tool-specific input data may indicate different categories of sentiments emerging in the customer feedbacks. The different categories of sentiments may include various emotional tones or attitudes expressed in the customer feedbacks about the target product. In an example, the different categories of sentiments may range from highly positive to highly negative, with neutral sentiments in between. The sentiment analysis tool may classifies the customer feedbacks into the different categories to provide a comprehensive overview of customer opinions. Examples of the different categories of sentiments may include, but are not limited to, highly positive, positive, neutral, slightly negative, negative, highly negative, and mixed.

For example, the tool-specific output data obtained from the sentiment analysis tool based on analysis of customer feedbacks about the heat monitoring device may indicate the first customer feedback to be slightly negative, the second customer feedback to be positive, the third customer feedback to be mixed, the fourth customer feedback to be highly negative, the fifth customer feedback to be neutral, the sixth customer feedback to be highly positive, and the seventh customer feedback to be negative.

The report generation engine 112 may process tool-specific output data obtained from the plurality of analytical tools to identify probable quality concerns in the target product. The probable quality concerns may be defined as potential issues or defects in the target product that are likely to affect the performance, safety, or user satisfaction associated with the target product. The probable quality concerns may have a significant likelihood of being genuine problems that may require attention or intervention to prevent large-scale recall of the target product. For example, for a heat monitoring device, a probable quality concern may be inconsistent temperature readings at high temperatures. The probable quality concern in the heat monitoring device may be identified through analysis of user reviews reporting discrepancies in the temperature readings, coupled with an increasing trend in complaints related to inaccurate temperature readings for the one or more products that have at least one similarity with the target product and a high risk score associated with temperature accuracy issues.

Further, the report generation engine 112 may process tool-specific output data obtained from the plurality of analytical tools to generate an assessment report, including the probable quality concerns, corresponding to the target product. The assessment report may be a comprehensive document that summarizes findings, analysis, and recommendations resulting from a systematic evaluation of quality, performance, and potential risks associated with the target product, by implementing the plurality of analytical tools in accordance with the assessment workflow. The assessment report may include data-driven insights, the potential quality concerns, severity and trends of the potential quality concerns, historical context associated with the potential quality concerns, and suggested actions for addressing the potential quality concerns. For example, an assessment report for a heat monitoring device may include sections on overall sentiment analysis (e.g., 55% positive reviews), the potential quality concerns (e.g., temperature accuracy, battery life, mobile application connectivity), risk scores for each of the potential quality concerns, trend analysis showing a 40% increase in temperature accuracy related recalls or complaints, and recommendations such as urgent investigation into temperature sensor calibration and firmware updates for battery optimization.

In an example, the report generation engine 112 may generate one or more recommendations to mitigate the probable quality concerns in the target product. In an example, the one or more recommendations may include suggested actions, strategies, or solutions proposed to address, reduce, or eliminate the probable quality concerns identified in the target product. In an example, the one or more recommendations may be generated based on analysis of at least one of the RF data and historical actionable data describing historical actions, strategies, or solutions historically implemented to address quality concerns similar to the probable quality concerns. In one example, the one or more recommendations may be stored within the assessment report data 122.

The report generation engine 112 may incorporate the one or more recommendations in the assessment report. In an example, the assessment report may include one or more sections corresponding to the one or more recommendations. For example, for a heat monitoring device as a target product, the assessment report may include a first section stating, “a firmware update may be implemented to recalibrate temperature sensors across all target devices to address the temperature accuracy issue”. Further, the assessment report may include a second section stating, “quality control processes in the production line may be enhanced to focus on temperature sensor testing under various environmental conditions for addressing the temperature accuracy issue”. Further, the assessment report may include a third section stating, “a user guide may be developed and distributed for proper device placement and maintenance to minimize external factors affecting the accuracy of the temperature sensors”. Furthermore, the assessment report may include a fourth section stating, “a voluntary inspection program may be initiated for the heat monitoring devices already in use, offering free recalibration services if needed”. Moreover, the assessment report may include a fifth section stating, “a dedicated support hotline may be established for users experiencing temperature accuracy issues, providing real-time troubleshooting and data collection for further analysis”.

In an example, the warning generation engine 216 may analyze the assessment report to ascertain whether the assessment report indicates any quality concern corresponding to the target product. The assessment report may indicate one or more quality concern corresponding to the target product when the one or more quality concerns are identified by the system 100 during risk assessment of the target product. The assessment report may not indicate any quality concern when any quality concern is not identified by the system 100 during risk assessment of the target product.

Upon ascertaining that the assessment report does not indicate any quality concern corresponding to the target product, the warning generation engine 216 may forgo generating any warning message.

However, upon ascertaining the assessment report to indicate one or more quality concerns corresponding to the target product, the warning generation engine 216 may generate a warning message, for transmission to a user, to alert the user about the one or more quality concerns. The warning message may include the assessment report. In an example, the warning message may be a proactive alert generated by the system 100 to notify users or stakeholders about the one or more quality concerns identified during the risk assessment of the target product. The warning message may include a summary of the one or more quality concerns and potential impact of the one or more quality concerns. For example, for a heat monitoring device as a target product, a warming message may be “ATTENTION: Critical quality concern detected for the heat monitoring device having model number HM-2000. Analysis of recent customer feedback indicates a significant increase in temperature accuracy related issues, with a 40% rise in the last two weeks. The temperature accuracy issue may pose potential safety risks in industrial settings. Immediate investigation and possible recalibration are recommended. Please refer to the attached assessment report for detailed findings and recommended actions”. In one example, the warning message may be stored within the assessment report data 122. Thus, the present subject matter facilitates proactive identification of quality concerns associated with the target product and facilitates proactive mitigation of the identified quality concerns.

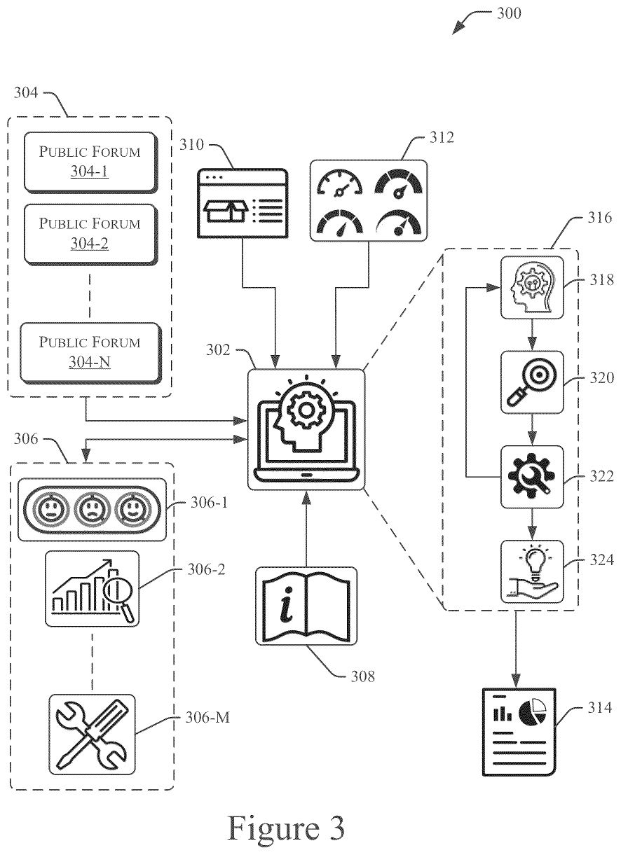

FIG. 3 illustrates a computing environment 300 implementing a risk assessment model 302 for product risk assessment, according to an example. In one example, the computing environment 300 may include the risk assessment model 302, a plurality of public forums 304, and a plurality of available analytical tools 306. In an example, the risk assessment model 302 may be an artificial intelligence/machine learning (AI/ML) model, such as a large language model (LLM), configured to evaluate and quantify potential risks associated with a target product based on pre-defined instructions 308. The risk assessment model 302 may be fed with the pre-defined instructions 308 for enabling the risk assessment model 302 to act as an intelligent orchestrator for implementing the functions of the system 100 or any of the engine(s) 102 of the system 100. The pre-defined instructions 308 may be essential guidelines that may shape the behaviour of the risk assessment model 302. In an example, the pre-defined instructions 308 may be generated and provided by developers of the risk assessment model 302. In an example, the risk assessment model 302 may be implemented by the system 100 to implement the functions of the system 100 or any of the engine(s) 102 of the system 100.

The plurality of public forums 304 may include N number of public forums 304-1, 304-2, . . . , 304-N, where N may be a natural number greater than 1, each of which may be individually referred to as public forum 304 and all of which may be collectively referred to as the public forums 304. The plurality of public forums 304 may include any publicly accessible online platforms or digital spaces where information, opinions, experiences, and discussions can be shared about the products, including the target product, manufactured and distributed by the organization. Examples of the plurality of public forums 304 may include, but are not limited to, social media platforms, online review websites, discussion boards, industry-specific forums, product regulatory body databases like food and drug administration (FDA) database, blogs, consumer complaint websites, and product-specific community forums.

The plurality of available analytical tools 306 may include M number of analytical tools 306-1, 306-2, . . . , 306-M, where M may be a natural number greater than 1, each of which may be individually referred to as available analytical tool 306 and all of which may be collectively referred to as the available analytical tools 306. Each of available analytical tools 306 may be configured to utilize a unique technique to comprehend corresponding input data and generate corresponding output data. In an example, each of the available analytical tools 306 may be module(s) designed to process and analyze the corresponding input data according to the unique technique to generate the corresponding output data. Examples of the available analytical tools 306 may include, but are not limited to, a data mining tool, a natural language processing tool, a sentiment analysis tool 306-1, a topic modelling tool, a trend analysis tool 306-2, a statistical analysis tool, and any other customized tool 306-M, such as a customized machine learning tool, specifically configured to process and analyze the corresponding input data in a pre-configured manner.

For conducting risk assessment of a target product, the risk assessment model 302 may be fed with a user input 310. The user input 310 may include at least one of a unique identifier representing the target product and a description of the target product. In one example; the target product may be from any industry, including, but not limited to, a pharmaceutical product, such as a medicine and a medical device, such as a heat monitoring device and a blood glucose monitoring system; an electronic device, such as a wearable fitness tracker and a laptop; an automative, such as a car; an automotive product, such as a clutch; a consumer product, such as a vacuum cleaner and a geyser; and home appliance and automation devices, such as a smart home thermostat and a refrigerator.

The risk assessment model 302 may further be fed with pre-defined importance scores 312 assigned to each of the public forums 304. In an example, a corresponding pre-defined importance score, from the pre-defined importance scores 312, associated with a public forum of the public forums 304 may be a pre-defined numerical value assigned to the public forum. The corresponding pre-defined importance score may reflect relative significance, credibility, or impact of the public forum in the context of risk assessment of the target product. For example, a popular consumer electronics review website may be one of the public forums 304 that is assigned an importance score of 0.9 on a scale of 0 to 1, indicating high reliability and relevance of the popular consumer electronics review website. Further, a general social media platform may be one of the public forums 304 that is assigned an importance score of 0.6, reflecting moderate relevance but potentially lower reliability of the general social media platform. Further, a niche forum dedicated to a specific category, to which the target product belong, may be one of the public forums 304 that is assigned an importance score of 0.8, due to focused and potentially expert user base of the niche forum dedicated to the specific category. Furthermore, a review section of an e-commerce platform may be one of the public forums 304 that is assigned an importance score of 0.7, balancing the wide reach of the e-commerce platform with potential biases in customer reviews. Moreover, an FDA database or any other similar database may be one of the public forums 304 that is assigned an importance score of 0.95, indicating high credibility of the FDA database for being an official source.

In an example, during the risk assessment of the target product, the risk assessment model 302 may parse forum data available on the plurality of public forums 304 to retrieve recall and feedback (RF) data corresponding to the target product to be assessed for identifying potential quality concerns in the target product. The forum data may include information, such as user posts, comments, reviews, ratings, and other forms of user-generated content, available on the plurality of public forums 304. The RF data may be retrieved based on at least one of the unique identifier and the description of the target product included in the user input 310. The RF data may be a subset of the forum data and may include information that is relevant for assessment of the target product. For instance, the RF data may include at least one of public feedback data associated with the target product and historical recall data associated with one or more products having at least one similarity with the target product. The at least one similarity may include similarity in composition, manufacturing process, and/or usage of the one or more products with the target product. The public feedback data may include opinions, comments, reviews, ratings, and discussions of various users about the target product. The historical recall data may encompass the description of investigations carried out and findings documented during historical recalls associated with the one or more products. For example, the historical recall data may include data, such as recall reason, product type, and product description, obtained from an FDA database or a similar database in relation to historical recalls associated with the one or more products. In an example, the RF data may be a processed form of the subset of the forum data that is relevant for assessment of the target product.

The risk assessment model 302 may analyze the RF data using a plurality of analytical tools from the plurality of available analytical tools 306 to identify probable quality concerns in the target product and generate an assessment report 314, including the probable quality concerns, corresponding to the target product. In an example, the risk assessment model 302 may implement multiple processing steps 316 for analyzing the RF data to identify the probable quality concerns and generate the assessment report. The multiple processing steps 316 may include thought generation step 318, observation step 320, an action step 322, and an answer step 324. During the thought generation step 318, the risk assessment model 302 may generate one or more thoughts describing reasoning for implementing a particular function of the system 100. During the observation step 320, the risk assessment model 302 may observe feedbacks associated with previously generated thoughts and previously implemented actions to generate one or more observations. During the action step 322, the risk assessment model 302 may implement one or more actions based on the one or more thoughts and the one or more observations. The thought generation step 318, the observation step 320, and the action step 322 may be repeated continuously until the particular function of the system 100 is implemented in entirety, resulting in generation of an answer at the answer step 324.

For identifying the probable quality concerns and generating the assessment report 314, the risk assessment model 302 may identify the plurality of analytical tools to be implemented for assessing the target product and determine a sequential order of the plurality of analytical tools to be followed for assessing the target product. The risk assessment model 302 may further generate tool-specific input data corresponding to each of the plurality of analytical tools based on analysis of at least the RF data. The tool-specific input data corresponding to each of the plurality of analytical tools may be generated based on the pre-defined importance scores 312 assigned to the public forums 304. For each analytical tool of the plurality of analytical tools, the risk assessment model 302 may analyze the tool-specific input data by implementing the analytical tool in accordance with the sequential order to obtain tool-specific output data from the analytical tool. The risk assessment model 302 may process tool-specific output data obtained from the plurality of analytical tools to identify the probable quality concerns in the target product and generate the assessment report 314.

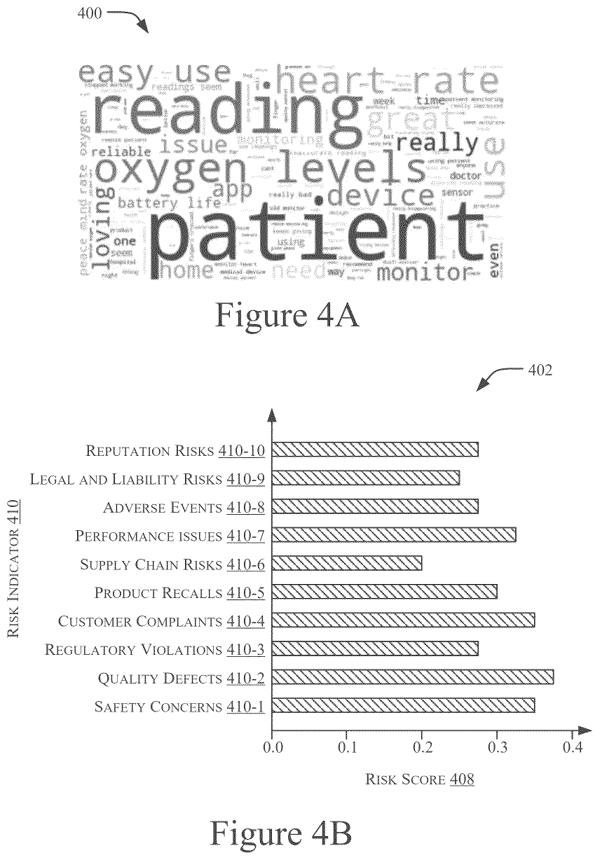

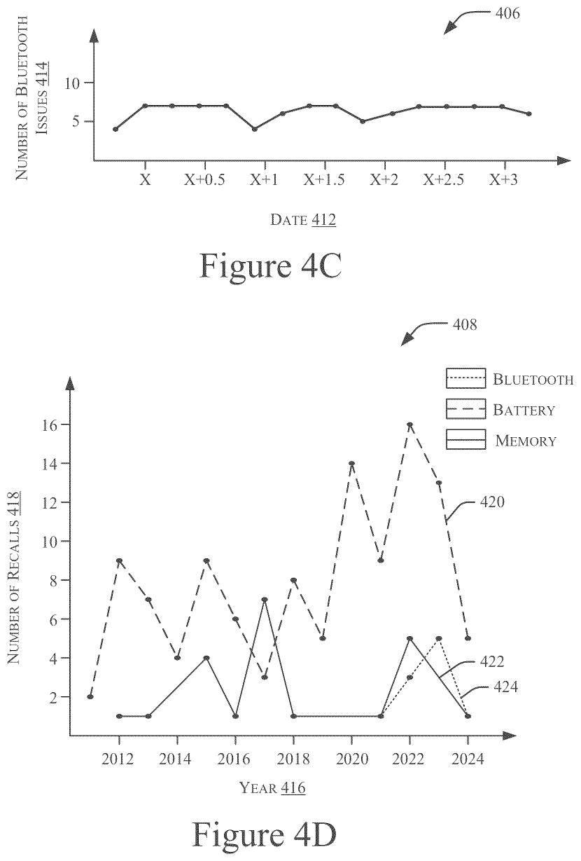

FIG. 4A, FIG. 4B, FIG. 4C, and FIG. 4D illustrate exemplary output data 400, 402, 404, and 406 obtained from various analytical tools, say a plurality of analytical tools of the plurality of available analytical tools 306, implemented by the system 100 for product risk assessment, according to an example.

FIG. 4A illustrates the exemplary output data 400 obtained from a data visualizing tool implemented by the system 100 during risk assessment of a heat monitoring device as a target product. The exemplary output data 400 may be a word cloud representing keywords detected in tool-specific input data by the data visualizing tool. The tool-specific input data may be generated by the system 100, specifically for the data visualizing tool, based on analysis of recall and feedback (RF) data associated with the heat monitoring device.

FIG. 4B illustrates the exemplary output data 402 obtained from a risk score analysis tool implemented by the system 100 during risk assessment of a heat monitoring device as a target product. The exemplary output data 402 may be a graph of exemplary risk scores 408 determined by the risk score analysis tool corresponding to each risk indicator of various risk indicators 410. The risk indicators 410 may include safety concerns 410-1, quality defects 410-2, regulatory violations 410-3, customer complaints 410-4, product recalls 410-5, supply chain risks 410-6, performance issues 410-7, adverse events 410-8, legal and liability risks 410-9, and reputation risks 410-10 associated with the heat monitoring device. The X-axis of the graph denotes the risk scores 408 and the Y-axis of the graph denotes the risk indicators 410. The risk scores 408 may be assigned on a scale of 0 to 0.5, 0 being a lowest risk score and 0.5 being a highest risk score. For instance, according to the graph of the exemplary output data 402, a risk score corresponding to the safety concerns 410-1 is 0.35, a risk score corresponding to the quality defects 410-2 is 0.375, a risk score corresponding to the regulatory violations 410-3 is 0.275, a risk score corresponding to the customer complaints 410-4 is 0.35, a risk score corresponding to the product recalls 410-5 is 0.3, a risk score corresponding to the supply chain risks 410-6 is 0.2, a risk score corresponding to the performance issues 410-7 is 0.325, a risk score corresponding to the adverse events 410-8 is 0.275, a risk score corresponding to the legal and liability risks 410-9 is 0.25, and a risk score corresponding to the reputation risks 410-10 is 0.275.

FIG. 4C illustrates the exemplary output data 404 obtained from a trend analysis tool implemented by the system 100 during risk assessment of a heat monitoring device as a target product. The exemplary output data 404 may be obtained by the trend analysis tool based on analysis of tool-specific input data, generated by the system 100, including customer feedbacks directed to a Bluetooth issue in the heat monitoring device over past three months. The exemplary output data 404 may be a graph indicating a trend of Bluetooth issues over time, determined by the trend analysis tool in the tool-specific input data. The X-axis of the graph denotes date 412 and the Y-axis of the graph denotes a number of Bluetooth issues 414. The date 412 may include date X, date X+0.5 being half month later than the date X, date X+1 being one month later than the date X, date X+1.5 being one and a half month later than the date X, date X+2 being two months later than the date X, date X+2.5 being two and a half month later than the date X, and data X+3 being three months later than the date X. From left to right of the date 412, the dots may indicate a trend of the number of Bluetooth issues 414, starting from four Bluetooth issues, then seven Bluetooth issues, then seven Bluetooth issues, then seven Bluetooth issues, then seven Bluetooth issues, then four Bluetooth issues, then six Bluetooth issues, then seven Bluetooth issues, then seven Bluetooth issues, then five Bluetooth issues, then six Bluetooth issues, then seven Bluetooth issues, then seven Bluetooth issues, then seven Bluetooth issues, then seven Bluetooth issues, and ending at six Bluetooth issues over various dates.

FIG. 4D illustrates the exemplary output data 406 obtained from a trend analysis tool implemented by the system 100 during risk assessment of a heat monitoring device as a target product. The exemplary output data 406 may be obtained by the trend analysis tool based on analysis of tool-specific input data, generated by the system 100, including historical recall data associated with historical recalls related to a Bluetooth issue, a battery issue, and a memory issue in the heat monitoring device, over various years. The exemplary output data 406 may be a graph indicating a trend of Bluetooth-related recalls, battery-related recalls, and memory-related recalls over time, determined by the trend analysis tool in the tool-specific input data. The X-axis of the graph denotes year 416 and the Y-axis of the graph denotes a number of recalls 418.

For instance, according to the graph of the exemplary output data 406, due to Bluetooth-related issues depicted by wide dotted line 420, two recalls occurred in the year 2011, nine recalls occurred in the year 2012, five recalls occurred in the year 2013, four recalls occurred in the year 2014, nine recalls occurred in the year 2015, six recalls occurred in the year 2016, three recalls occurred in the year 2017, eight recalls occurred in the year 2018, five recalls occurred in the year 2019, fourteen recalls occurred in the year 2020, nine recalls occurred in the year 2021, sixteen recalls occurred in the year 2022, thirteen recalls occurred in the year 2023, and five recalls occurred in the year 2024. Further, due to the memory-related issues depicted by solid line 422, one recall occurred in the year 2012, one recall occurred in the year 2013, four recalls occurred in the year 2015, one recall occurred in the year 2016, seven recalls occurred in the year 2017, one recall occurred in the year 2018, one recall occurred in the year 2020, one recall occurred in the year 2021, five recalls occurred in the year 2022, and one recall occurred in the year 2024. Furthermore, due to battery-related issues depicted by narrow dotted line 424, one recall occurred in the year 2021, three recalls occurred in the year 2022, five recalls occurred in the year 2023, and one recall occurred in the year 2024.

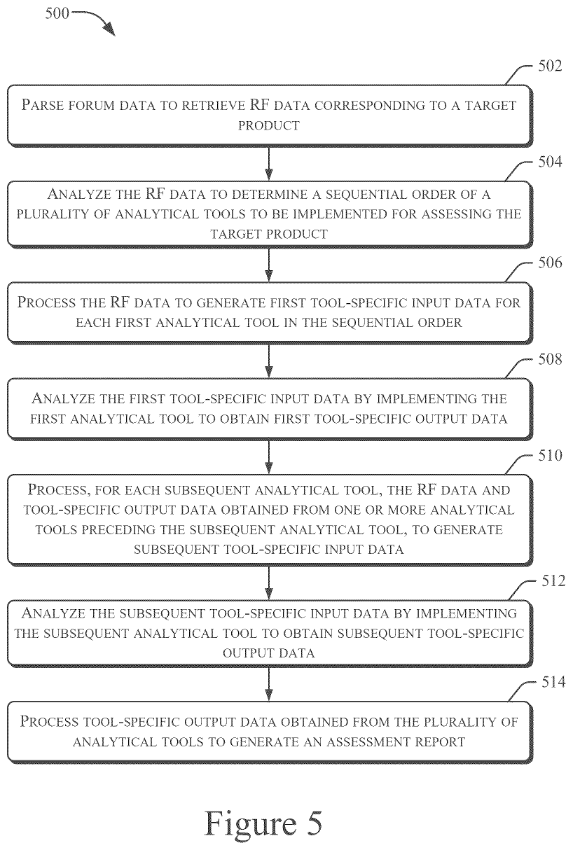

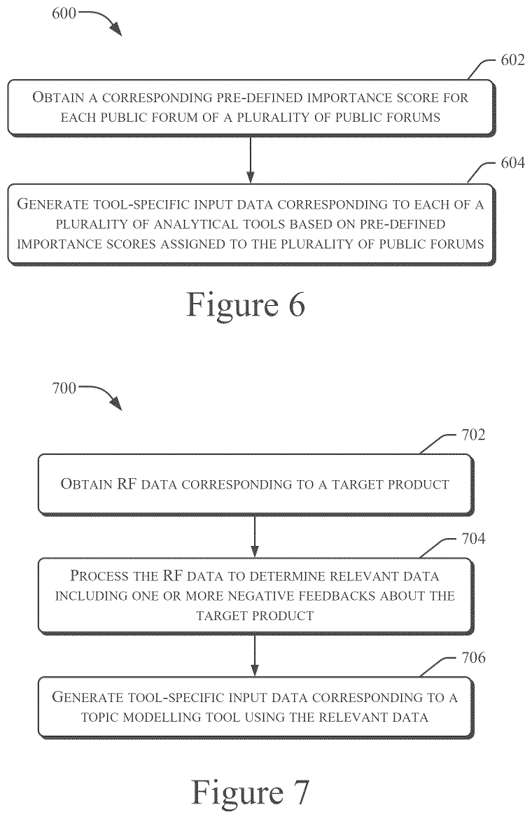

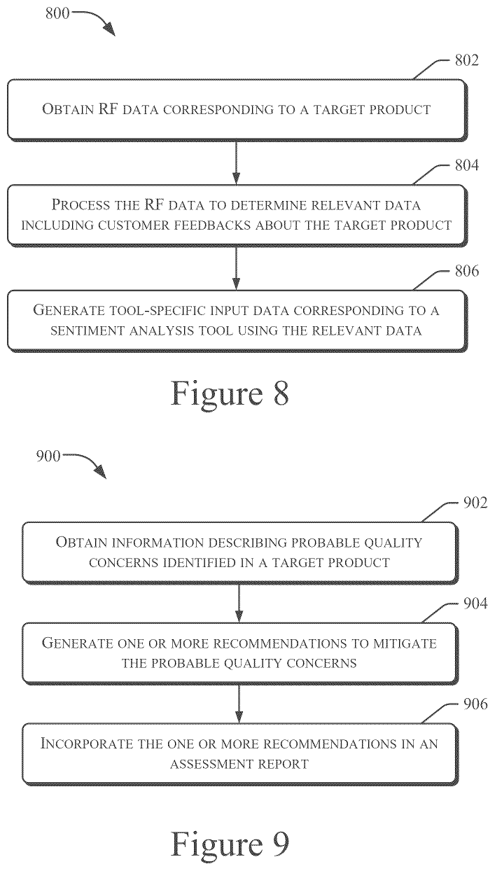

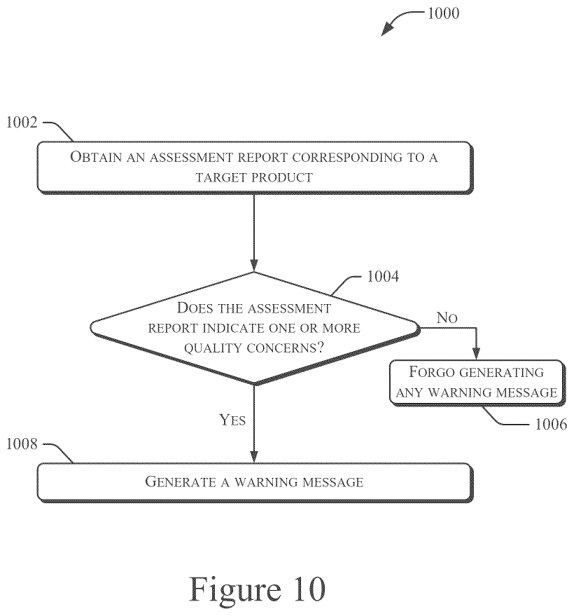

FIG. 5, FIG. 6, FIG. 7, FIG. 8, FIG. 9, and FIG. 10 illustrate example methods 500, 600, 700, 800, 900, and 1000, respectively, for product risk assessment. The order in which the methods are described is not intended to be construed as a limitation, and any number of the described method blocks may be combined in any order to implement the methods, or an alternative method. Further, the methods 500, 600, 700, 800, 900, and 1000 may be implemented by processing resource or computing device(s) through any suitable hardware, non-transitory machine-readable instructions, or combination thereof.

It may also be understood that methods 500, 600, 700, 800, 900, and 1000 may be performed by programmed computing devices, such as the system 100 as depicted in FIG. 1 and FIG. 2, or the risk assessment model 302 as depicted in FIG. 3. Furthermore, the methods 500, 600, 700, 800, 900, and 1000 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 500, 600, 700, 800, 900, and 1000 are described below with reference to the system 100 as described above; other suitable systems for the execution of these methods may also be utilized. Additionally, implementation of the methods 500, 600, 700, 800, 900, and 1000 is not limited to such examples.

FIG. 5 illustrates the method 500 for a product risk assessment, according to an example.

At block 502, forum data available on a plurality of public forums may be parsed to retrieve recall and feedback (RF) data corresponding to a target product to be assessed for identifying potential quality concerns in the target product. In one example; the target product may be from any industry, including, but not limited to, a pharmaceutical product, such as a medicine and a medical device, such as a heat monitoring device and a blood glucose monitoring system; an electronic device, such as a wearable fitness tracker and a laptop; an automative, such as a car; an automotive product, such as a clutch; a consumer product, such as a vacuum cleaner and a geyser; and home appliance and automation devices, such as a smart home thermostat and a refrigerator. The plurality of public forums may include any publicly accessible online platforms or digital spaces where information, opinions, experiences, and discussions can be shared about the products, including the target product, manufactured and distributed by the organization. Examples of the plurality of public forums may include, but are not limited to, social media platforms, online review websites, discussion boards, industry-specific forums, product regulatory body databases like food and drug administration (FDA) database, blogs, consumer complaint websites, and product-specific community forums. Thus, the forum data may include information, such as user posts, comments, reviews, ratings, and other forms of user-generated content, available on the plurality of public forums.

In addition to information that is relevant for assessment of the target product, the forum data may include information that is irrelevant for the assessment of the target product. Thus, the forum data may be parsed to retrieve the RF data corresponding to the target product. The RF data may be a subset of the forum data and may include information that is relevant for assessment of the target product. For instance, the RF data may include at least one of public feedback data associated with the target product and historical recall data associated with one or more products having at least one similarity with the target product. The at least one similarity may include similarity in composition, manufacturing process, and/or usage of the one or more products with the target product. The public feedback data may include opinions, comments, reviews, ratings, and discussions of various users about the target product. The historical recall data may encompass the description of investigations carried out and findings documented during historical recalls associated with the one or more products. For example, the historical recall data may include data, such as recall reason, product type, and product description, obtained from an FDA database or a similar database in relation to historical recalls associated with the one or more products. In an example, the RF data may be a processed form of the subset of the forum data that is relevant for assessment of the target product. In an example, an AI/ML model, say the risk assessment model 302, may be implemented for parsing the forum data to retrieve the RF data corresponding to the target product. In an example, the forum data may be accessed from external databases, say the databases 202.

At block 504, the RF data may be analyzed to identify a plurality of analytical tools to be implemented for assessing the target product and determine a sequential order of the plurality of analytical tools to be followed for assessing the target product. The sequential order of the plurality of analytical tools may be included in an assessment workflow that is to be followed for assessing the target product. In an example, the AI/ML model may be implemented for analyzing the RF data to identify the plurality of analytical tools and the sequential order of the plurality of analytical tools. Each of the plurality of analytical tools may be configured to utilize a unique technique to comprehend corresponding input data and generate corresponding output data. In an example, each of the plurality of analytical tools may be module(s) designed to process and analyze the corresponding input data according to the unique technique to generate the corresponding output data. The plurality of analytical tools may include a data mining tool, a natural language processing tool, a sentiment analysis tool, a topic modelling tool, a trend analysis tool, a statistical analysis tool, and any other customized tool, such as a customized machine learning tool, specifically configured to process and analyze the RF data in a pre-configured manner.

In an example, for identifying the plurality of analytical tools and determining the sequential order of the plurality of analytical tools, the RF data may be classified into distinct categories and the proportion of each of the distinct categories may be determined based on the analysis of the RF data. The plurality of analytical tools may be identified and the sequential order of the plurality of analytical tools may be determined based on the distinct categories and the proportion of each of the distinct categories. For instance, upon determining that the RF data contains 60% textual customer reviews, 30% numerical ratings, and 10% image-based feedback about the target product, a text analysis tool, a statistical analysis tool, and an image processing tool may be selected, from various analytical tools available to the system 100, for implementing during assessment of the target product. Further, in the sequential order, the text analysis tool may be prioritized, followed by the statistical analysis tool and the image processing tool. In another instance, upon determining that the RF data comprises 30% historical recall data from the FDA database, 50% customer reviews from e-commerce platforms, and 20% social media mentions, an analytical tools specialized for analysis of the historical recall data, a sentiment analysis tool, and a trend analysis tool may be selected, from various analytical tools available to the system 100, for implementing during assessment of the target product. Further, in the sequential order, the analytical tool specialized for analysis of the historical recall data may be prioritized, followed by the sentiment analysis tool for analysis of the customer reviews, and finally the trend analysis tool to process the social media mentions.

In an example, the sequential order may be a linear sequence of the plurality of analytical tools, according to which one analytical tool, of the plurality of analytical tools, is implemented at a time and output of that analytical tool is processed before implementing any subsequent analytical tool in the sequential order. In another example, the sequential order may be a non-linear sequence of the plurality of analytical tools, according to which multiple analytical tools, of the plurality of analytical tools, may be simultaneously implemented at a time, and output of the multiple analytical tools may be processed before implementing any subsequent analytical tool(s) in the sequential order. For example, according to an example sequential order, the sentiment analysis tool and the trend analysis tool may be implemented simultaneously, followed by the topic modelling tool, and then followed by simultaneous implementation of the natural language processing tool and the statistical analysis tool.

In an example, the plurality of analytical tools may be identified and the sequential order of the plurality of analytical tools may be determined based on factors such as reliability of each of the plurality of public forums from which the RF data is retrieved, the distinct categories and the proportion of each of the distinct categories, computational resource requirements, and the potential impact of each distinct category on identification of the potential quality concerns. The sequential order may also consider the sequential dependencies between the plurality of analytical tools, prioritizing analysis that provide foundational insights for subsequent analyses using the plurality of analytical tools. Thus, the determined sequential order may provide a strategically sequenced combination of the plurality of analytical tools such that available data, i.e., the RF data, corresponding to the target product may be efficiently analysed using the plurality of analytical tools for identification of potential quality concerns in the target product.

At block 506, the RF data may be processed to generate first tool-specific input data corresponding to each first analytical tool in the sequential order of the plurality of analytical tools. In an example, the AI/ML model may be implemented for processing the RF data to generate the first tool-specific input data. The first tool-specific input data corresponding to the first analytical tool may be data that has been processed, formatted, and structured to meet the specific requirements and constraints of the particular analytical tool, ensuring the first analytical tool performs its specialized function effectively.

In an example, for generating the first tool-specific input data, tool description data corresponding to the first analytical tool may be processed along with the RF data to determine most appropriate data format and content to be used within the first tool-specific input data. The tool description data may include specifications of the first analytical tool, input data constraints associated with the first analytical tool, and processing capabilities of the first analytical tool. For example, if the first analytical tool is determined as a sentiment analysis tool, first tool-specific input data may be generated to include cleaned and standardized text from customer reviews, with content filtered for relevant aspects such as accuracy, battery life, and Bluetooth functionality of the target product, such as the heat monitoring device. Further, if the first analytical tool is determined as a topic modelling tool, first tool-specific input data may be generated to include a corpus of individual feedback documents with stop words removed and words lemmatized, and content filtered for product-specific terminologies.

At block 508, for each first analytical tool of the plurality of analytical tools, the first tool-specific input data may be analyzed by implementing the first analytical tool to obtain first tool-specific output data from the first analytical tool. In an example, the AI/ML model may be implemented for providing the first tool-specific input data to the first analytical tool and obtaining the first tool-specific output data from the first analytical tool. The first tool-specific output data obtained from the first analytical tool may indicate results, insights, or processed information generated by the first analytical tool after analyzing the first tool-specific input data. For example, if the first analytical tool is determined as a sentiment analysis tool, the sentiment analysis tool may analyze the first tool-specific input data, such as 10,000 customer reviews from various sources including e-commerce platforms, social media, and industry forums. Based on analysis of the first tool-specific input data, the sentiment analysis tool may generate the first tool-specific output data that classifies the customer reviews as 55% positive reviews, 35% negative reviews, and 10% neutral reviews, thereby identifying 3,500 negative reviews which may be utilized for further analysis by the system 100.

At block 510, for each subsequent analytical tool after the first analytical tool in the sequential order, the RF data and tool-specific output data obtained from one or more analytical tools preceding the subsequent analytical tool may be processed in the sequential order, to generate subsequent tool-specific input data corresponding to the subsequent analytical tool. In an example, the AI/ML model may be implemented for processing the RF data and the tool-specific output data obtained from the one or more analytical tools to generate the subsequent tool-specific input data. The subsequent tool-specific input data corresponding to the subsequent analytical tool may be data that has been processed, formatted, and structured to meet the specific requirements and constraints of the subsequent analytical tool, ensuring the subsequent analytical tool performs its specialized function effectively.

In an example, for generating the subsequent tool-specific input data, tool description data corresponding to the subsequent analytical tool may be processed along with the RF data and the tool-specific output data obtained from the one or more analytical tools to determine most appropriate data format and content to be used within the subsequent tool-specific input data. The tool description data may include specifications of the subsequent analytical tool, input data constraints associated with the subsequent analytical tool, and processing capabilities of the subsequent analytical tool. For example, if the first analytical tool is determined as the sentiment analysis tool and the subsequent analytical tool is determined as the topic modelling tool, the subsequent tool-specific input data may be generated by processing the RF data and the first tool-specific output data from the sentiment analysis tool. For example, the subsequent tool-specific input data may include the 3,500 negative reviews identified by the sentiment analysis tool.

At block 512, for each subsequent analytical tool after the first analytical tool in the sequential order, the subsequent tool-specific input data may be analyzed by implementing the subsequent analytical tool to obtain subsequent tool-specific output data from the analytical tool. The subsequent tool-specific output data obtained from the subsequent analytical tool may indicate results, insights, or processed information generated by the subsequent analytical tool after analyzing the subsequent tool-specific input data. For example, the subsequent tool-specific output data may be obtained from the topic modelling tool by processing the 3,500 negative reviews. The subsequent tool-specific output data obtained from the topic modelling tool may indicate three primary topics including temperature accuracy, battery life, and mobile application connectivity issues associated with the heat monitoring device. For the temperature accuracy issue, the subsequent tool-specific output data obtained from the topic modelling tool may indicate frequently appearing keywords such as “inconsistent”, “drift”, and “calibration”. For the battery life issue, the subsequent tool-specific output data obtained from the topic modelling tool may indicate frequently appearing keywords such as “short duration”, “frequent charging”, and “unexpected shutdowns”. For the mobile application connectivity issue, the subsequent tool-specific output data obtained from the topic modelling tool may indicate frequently appearing keywords such as “disconnects”, “sync failures”, and “data loss”.

The RF data, the first tool-specific output data obtained from the sentiment analysis tool, and the subsequent tool-specific output data obtained from the topic modelling tool may be processed to generate subsequent tool-specific input data corresponding to any other subsequent analytical tool. For example, the RF data, the first tool-specific output data obtained from the sentiment analysis tool, and the subsequent tool-specific output data may be processed to generate subsequent tool-specific input data corresponding to a risk score analysis tool. The risk score analysis tool may be implemented to analyze the subsequent tool-specific input data specifically generated corresponding to the risk score analysis tool. Subsequent tool-specific output data obtained from the risk score analysis tool may indicate risk scores assigned to each of the three primary topics by the risk score analysis tool. For example, based on analysis of the subsequent tool-specific input data corresponding to the risk score analysis tool, the temperature accuracy issue may be assigned a risk score of 8.5 out of 10, the battery life issue may be assigned a risk score of 7.2 out of 10, and the mobile application connectivity issue is assigned a risk score of 6.8 out of 10, reflecting importance of addressing each corresponding primary topic before the corresponding primary topic causes any adverse damage, such as large-scale recalls or consumer safety-concerning accident. In another example, the subsequent tool-specific output data obtained from the risk score analysis tool may indicate risk score for various pre-defined risk indicators corresponding to each of the primary topics identified in the target product. Example of the various pre-defined risk indicators may include, but are not limited to, reputation risks, legal and liability risks, adverse events, performance issues, supply chain risks, product recalls, customer complaints, regulatory violations, quality defects, and safety concerns associated with the target product.

The RF data, the first tool-specific output data obtained from the sentiment analysis tool, and the subsequent tool-specific output data obtained from the topic modelling tool and the risk score analysis tool may be processed to generate subsequent tool-specific input data corresponding to any other subsequent analytical tool. For example, the first tool-specific output data obtained from the sentiment analysis tool and the subsequent tool-specific output data may be processed to generate subsequent tool-specific input data corresponding to a trend analysis tool. The trend analysis tool may be implemented to analyze the subsequent tool-specific input data specifically generated corresponding to the trend analysis tool. Subsequent tool-specific output data obtained from the trend analysis tool may indicate trends and patterns identified by the trend analysis tool in the subsequent tool-specific input data. For example, based on analysis of the subsequent tool-specific input data, such as negative reviews over past three months, corresponding to the trend analysis tool, a sharp 40% increase in negative reviews related to the temperature accuracy issue may be identified over past two weeks, potentially indicating a recent quality control issue or a recent software update issue. Further, a steady 10% rise in negative reviews related to the battery life issue may be identified, indicating that the battery issue is a persistent and growing problem. Further, negative reviews related to the mobile application connectivity issue may be identified to be fluctuating without a clear trend, possibly reflecting intermittent problems or varying user experiences.

In another example, based on analysis of the subsequent tool-specific input data, such as the historical recall data associated with the primary topics identified by the topic modelling tool, the subsequent tool-specific output data obtained from the trend analysis tool may uncover one historical recall for a similar temperature accuracy issue in one of the one or more products, that have at least one similarity with the target product, two years ago. The historical recall may be analyzed to identify that the historical recall occurred due to faulty sensors which led to overheating risks. Further, the subsequent tool-specific output data obtained from the trend analysis tool may indicate that the battery life issue and the mobile application connectivity issue have not resulted in recalls historically, indicating that the battery life issue and the mobile application connectivity issue are less likely to trigger recalls unless safety is directly impacted by the battery life and the mobile application connectivity issues.

Although an exemplary sequential order of the sentiment analysis tool, the topic modelling tool, the risk score analysis tool, and the trend analysis tool has been described, the exemplary sequence order is not intended to be construed as a limitation, and the sentiment analysis tool, the topic modelling tool, the risk score analysis tool, the trend analysis tool, and any other analytical tools may be implemented in a different sequential order to implement the functionalities of the method 500 and the system 100.

At block 514, tool-specific output data obtained from the plurality of analytical tools may be processed to identify probable quality concerns in the target product. The probable quality concerns may be defined as potential issues or defects in the target product that are likely to affect the performance, safety, or user satisfaction associated with the target product. The probable quality concerns may have a significant likelihood of being genuine problems that may require attention or intervention to prevent large-scale recall of the target product. For example, for a heat monitoring device, a probable quality concern may be inconsistent temperature readings at high temperatures. The probable quality concern in the heat monitoring device may be identified through analysis of user reviews reporting discrepancies in the temperature readings, coupled with an increasing trend in complaints related to inaccurate temperature readings for the one or more products that have at least one similarity with the target product and a high risk score associated with temperature accuracy issues.

Further, at block 514, the tool-specific output data obtained from the plurality of analytical tools may be processed to generate an assessment report, including the probable quality concerns, corresponding to the target product. The assessment report may be a comprehensive document that summarizes findings, analysis, and recommendations resulting from a systematic evaluation of quality, performance, and potential risks associated with the target product, by implementing the plurality of analytical tools in accordance with the assessment workflow. The assessment report may include data-driven insights, the potential quality concerns, severity and trends of the potential quality concerns, historical context associated with the potential quality concerns, and suggested actions for addressing the potential quality concerns. For example, an assessment report for a heat monitoring device may include sections on overall sentiment analysis (e.g., 55% positive reviews), the potential quality concerns (e.g., temperature accuracy, battery life, mobile application connectivity), risk scores for each of the potential quality concerns, trend analysis showing a 40% increase in temperature accuracy related recalls or complaints, and recommendations such as urgent investigation into temperature sensor calibration and firmware updates for battery optimization. Thus, the present subject matter facilitates proactive identification of quality concerns associated with the target product and facilitates proactive mitigation of the identified quality concerns.

FIG. 6 illustrates the method 600 of generating input data for various analytical tools to be implemented for product risk assessment of a target product, according to an example. The various analytical tools may be the plurality of analytical tools identified at block 504 of the method 500.

At block 602, for each public forum of a plurality of public forums, a corresponding pre-defined importance score assigned to the public forum may be obtained. The plurality of public forums may include any publicly accessible online platforms or digital spaces where information, opinions, experiences, and discussions can be shared about the products, including the target product, manufactured and distributed by the organization. Examples of the plurality of public forums may include, but are not limited to, social media platforms, online review websites, discussion boards, industry-specific forums, product regulatory body databases like food and drug administration (FDA) database, blogs, consumer complaint websites, and product-specific community forums. In an example, the corresponding pre-defined importance score may be a pre-defined numerical value assigned to the public forum. The corresponding pre-defined importance score may reflect relative significance, credibility, or impact of the public forum in the context of the product risk assessment of the target product.

For example, a popular consumer electronics review website may be one of the plurality of public forums that is assigned an importance score of 0.9 on a scale of 0 to 1, indicating high reliability and relevance of the popular consumer electronics review website. Further, a general social media platform may be one of the plurality of public forums that is assigned an importance score of 0.6, reflecting moderate relevance but potentially lower reliability of the general social media platform. Further, a niche forum dedicated to a specific category, to which the target product belong, may be one of the plurality of public forums that is assigned an importance score of 0.8, due to focused and potentially expert user base of the niche forum dedicated to the specific category. Furthermore, a review section of an e-commerce platform may be one of the plurality of public forums that is assigned an importance score of 0.7, balancing the wide reach of the e-commerce platform with potential biases in customer reviews. Moreover, an FDA database or any other similar database may be one of the plurality of public forums that is assigned an importance score of 0.95, indicating high credibility of the FDA database for being an official source.

In an example, the corresponding pre-defined importance score may be pre-assigned to the public forum by a user, such as a subject matter expert (SME) having knowledge of the plurality of public forums or a user associated with the organization by which the target product is manufactured, or may be pre-generated. For instance, the SME may assign the corresponding pre-defined importance score based on their knowledge of reliability and relevance of the plurality of public forums. In another instance, the corresponding pre-defined importance score may be assigned by conducting surveys among target users to understand which public forums are trusted and relied on for information of the target product. In yet another instance, the corresponding pre-defined importance score may be generated based on analysis of historical performance information indicating how accurately different public forums have predicted or identified quality concerns in the past. In yet another instance, the corresponding pre-defined importance score may be generated based on analysis, utilizing machine learning techniques, of the correlation between data from different public forums and actual product quality concerns. In an example, the corresponding pre-defined importance score may be adjusted over time based on the accuracy and timeliness of information from each of the plurality of public forums. In an example, the corresponding pre-defined importance score may be obtained directly from the user. In another example, the corresponding pre-defined importance score may be pre-stored in a memory, say the memory 212, of the system 100 and may be obtained from the memory.

At block 604, tool-specific input data corresponding to each analytical tool of the plurality of analytical tools may be generated based on pre-defined importance scores assigned to the plurality of public forums. Thus, pre-defined importance scores assigned to the plurality of public forums may be used to weigh the contribution of data from different public forums when generating the tool-specific input data for each of the plurality of analytical tools. For example, while generating the tool-specific input data corresponding to a trend analysis tool, information available on the FDA database regarding a particular issue, such as a temperature accuracy issue, may be given more weightage than information available on the general social media platform regarding the particular issue.

FIG. 7 illustrates the method 700 of generating input data for various analytical tools to be implemented for product risk assessment of a target product, according to another example. The various analytical tools may be the plurality of analytical tools identified at block 504 of the method 500. The plurality of analytical tools may include at least a topic modelling tool.

At block 702, recall and feedback (RF) data corresponding to the target product may be obtained. In an example, the RF data may be retrieved at block 502 of the method 500 and may be pre-stored in a memory, say the memory 212, of the system 100. The RF data may thus be obtained from the memory. In another example, the RF data may be obtained directly once the RF data is retrieved at block 502 of the method 500.

At block 704, for generating tool-specific input data corresponding to the topic modelling tool, at least the RF data is processed to determine relevant data including one or more negative feedbacks about the target product. In an example, tool-specific output data obtained from one or more analytical tools preceding the topic modelling tool in a sequential order, identified at block 504 of the method 500, of the plurality of analytical tools may be processed along with the RF data to determine the relevant data. Each of the one or more negative feedbacks may indicate at least one quality concern in the target product. In an example, the one or more negative feedbacks about the target product may include critical, unfavourable, or dissatisfied comments, reviews, or reports from users, customers, or stakeholders that highlight issues, shortcomings, or problems with performance, quality, safety, or user experience of the target product. For example, for a heat monitoring device as a target product, the one or more negative feedbacks may include a first negative feedback “The temperature readings are consistently off by 5-10 degrees, making it unreliable for precise monitoring in our factory”, a second negative feedback “Battery life is much shorter than advertised. It barely lasts a full shift, which is unacceptable for continuous monitoring”, a third negative feedback “The mobile app keeps crashing when I try to sync data, causing us to lose critical temperature logs”, a fourth negative feedback “Device stopped working after exposure to high humidity, despite being marketed as suitable for industrial environments”, a fifth negative feedback “Alarm function failed to trigger when temperatures exceeded the set threshold, posing a serious safety risk in our facility”, and other similar negative feedbacks.

At block 706, tool-specific input data corresponding to the topic modelling tool may be generated using the relevant data. In an example, the relevant data may be pre-processed using various pre-processing techniques, such as data cleaning, formatting, feature extraction, and normalization, to generate the tool-specific input data corresponding to the topic modelling tool. Tool-specific output data obtained from the topic modelling tool based on analysis of the tool-specific input data may indicate one or more key quality concerns discussed in the negative feedbacks. The one or more key concerns may include primary issues related to quality, performance, or safety of the target product that emerge as distinct themes or topics. The one or more key concerns may be extracted and grouped by the topic modelling tool based on the frequency and co-occurrence of specific words or phrases in the negative feedbacks.

For example, the tool-specific output data obtained from the topic modelling tool based on analysis of negative feedbacks about a heat monitoring device may indicate three key quality concerns including temperature accuracy, battery life, and mobile application connectivity issues associated with the heat monitoring device. The temperature accuracy issue may be determined based on identification of a cluster of keywords, such as “inaccurate”, “inconsistent”, “deviation”, “drift”, and “calibration”, frequently appearing in the negative feedbacks, indicating a key concern about the ability of the heat monitoring device to provide precise temperature readings. Further, the battery life issue may be determined based on identification of a cluster of keywords, such as “short duration”, “dies quickly”, “power issues”, “frequent charging”, and “unexpected shutdowns”, frequently appearing in the negative feedbacks, highlighting a key concern about the power management and longevity during use of the heat monitoring device. Furthermore, the mobile application connectivity issue may be determined based on identification of a cluster of keywords, such as “disconnects”, “app crashes”, “sync failures”, “connectivity issues”, and “data loss” frequently appearing in the negative feedbacks, indicating a key concern about the reliability of accompanying software or mobile application of the heat monitoring device.

FIG. 8 illustrates the method 800 of generating input data for various analytical tools to be implemented for product risk assessment of a target product, according to yet another example. The various analytical tools may be the plurality of analytical tools identified at block 504 of the method 500. The plurality of analytical tools may include at least a sentiment analysis tool.

At block 802, recall and feedback (RF) data corresponding to the target product may be obtained. In an example, the RF data may be retrieved at block 502 of the method 500 and may be pre-stored in a memory, say the memory 212, of the system 100. The RF data may thus be obtained from the memory. In another example, the RF data may be obtained directly once the RF data is retrieved at block 502 of the method 500.

At block 804, for generating tool-specific input data corresponding to the sentiment analysis tool, at least the RF data is processed to determine relevant data including customer feedbacks about the target product. In an example, tool-specific output data obtained from one or more analytical tools preceding the sentiment analysis tool in a sequential order, identified at block 504 of the method 500, of the plurality of analytical tools may be processed along with the RF data to determine the relevant data. Each of the one or more negative feedbacks may indicate at least one quality concern in the target product. In an example, customer feedbacks about the target product may include opinions, comments, reviews, ratings, and experiences shared by users or consumers about the target product. The customer feedbacks can be positive, negative, or neutral, and may cover various aspects of the target product including the performance, quality, usability, and overall satisfaction of the target product. For example, for a heat monitoring device as a target product, the customer feedbacks may include a first customer feedback “The device is okay, but the battery life could be better. I find myself charging it more often than I would like”, a second customer feedback “I am pleased with this device. It performs well, has good battery life, and the app is user-friendly. It meets our needs effectively”, a third customer feedback “While the accuracy of the device is excellent, the short battery life is a significant drawback. It's a mix of great features and frustrating limitations”, a fourth customer feedback “This is the worst product I have ever purchased. It is completely unreliable, the customer service is terrible, and it is a waste of money. I strongly advise against buying it”, a fifth customer feedback “The heat monitor works as expected. It is neither exceptional nor disappointing. It does the job it is supposed to do”, a sixth customer feedback “This heat monitor is absolutely fantastic! It is incredibly accurate, easy to use, and has revolutionized our temperature management process. Best purchase we've made for our facility”, a seventh customer feedback “I am not satisfied with this heat monitor. The readings are inconsistent, and the app frequently crashes. It is causing more problems than it solves”, and other similar customer feedbacks.

At block 806, tool-specific input data corresponding to the sentiment analysis tool may be generated using the relevant data. In an example, the relevant data may be pre-processed using various pre-processing techniques, such as data cleaning, formatting, feature extraction, and normalization, to generate the tool-specific input data corresponding to the sentiment analysis tool. Tool-specific output data obtained from the sentiment analysis tool based on analysis of the tool-specific input data may indicate different categories of sentiments emerging in the customer feedbacks. The different categories of sentiments may include various emotional tones or attitudes expressed in the customer feedbacks about the target product. In an example, the different categories of sentiments may range from highly positive to highly negative, with neutral sentiments in between. The sentiment analysis tool may classifies the customer feedbacks into the different categories to provide a comprehensive overview of customer opinions. Examples of the different categories of sentiments may include, but are not limited to, highly positive, positive, neutral, slightly negative, negative, highly negative, and mixed.

For example, the tool-specific output data obtained from the sentiment analysis tool based on analysis of customer feedbacks about the heat monitoring device may indicate the first customer feedback to be slightly negative, the second customer feedback to be positive, the third customer feedback to be mixed, the fourth customer feedback to be highly negative, the fifth customer feedback to be neutral, the sixth customer feedback to be highly positive, and the seventh customer feedback to be negative.

FIG. 9 illustrate the method 900 of generating an assessment report based on the product risk assessment of a target product, according to an example.

At block 902, information describing probable quality concerns identified in the target product may be obtained. The probable quality concerns may be the probable quality concerns identified at block 514 of the method 500. The information may be pre-stored in a memory, say the memory 212, of the system and may be obtained from the memory. In another example, the information may be directly obtained after the probable quality concerns are identified at block 514 of the method 500.

At block 904, one or more recommendations to mitigate the probable quality concerns in the target product may be generated. In an example, the one or more recommendations may include suggested actions, strategies, or solutions proposed to address, reduce, or eliminate the probable quality concerns identified in the target product. In an example, the one or more recommendations may be generated based on analysis of at least one of RF data, retrieved at block 502 of the method 500, and historical actionable data describing historical actions, strategies, or solutions historically implemented to address quality concerns similar to the probable quality concerns.

At block 906, the one or more recommendations may be incorporated in the assessment report. In an example, the assessment report may include one or more sections corresponding to the one or more recommendations. For example, for a heat monitoring device as a target product, the assessment report may include a first section stating, “a firmware update may be implemented to recalibrate temperature sensors across all target devices to address the temperature accuracy issue”. Further, the assessment report may include a second section stating, “quality control processes in the production line may be enhanced to focus on temperature sensor testing under various environmental conditions for addressing the temperature accuracy issue”. Further, the assessment report may include a third section stating, “a user guide may be developed and distributed for proper device placement and maintenance to minimize external factors affecting the accuracy of the temperature sensors”. Furthermore, the assessment report may include a fourth section stating, “a voluntary inspection program may be initiated for the heat monitoring devices already in use, offering free recalibration services if needed”. Moreover, the assessment report may include a fifth section stating, “a dedicated support hotline may be established for users experiencing temperature accuracy issues, providing real-time troubleshooting and data collection for further analysis”.

FIG. 10 illustrates the method 1000 of warning about quality concerns identified in a target product, according to an example.

At block 1002, an assessment report corresponding to the target product may be obtained. In an example, the assessment report may be an assessment report generated at block 514 of the method 500 or at block 906 of the method 900. The assessment report may be pre-stored in a memory, say the memory 212, by the system 100 and may be obtained from the memory.

At block 1004, the assessment report may be analyzed to ascertain whether the assessment report indicates any quality concern corresponding to the target product. The assessment report may indicate one or more quality concern corresponding to the target product when the one or more quality concerns are identified by the system 100 during risk assessment of the target product. The assessment report may not indicate any quality concern when any quality concern is not identified by the system 100 during risk assessment of the target product.

Upon ascertaining that the assessment report does not indicate any quality concern corresponding to the target product (‘NO’ path from block 1004), generation of any warning message may be forgone, at block 1006. However, upon ascertaining the assessment report to indicate one or more quality concerns corresponding to the target product (‘YES’ path from block 1004), a warning message may be generated, for transmission to a user, to alert the user about the one or more quality concerns, at block 1008. The warning message may include the assessment report. In an example, the warning message may be a proactive alert generated to notify users or stakeholders about the one or more quality concerns identified during the risk assessment of the target product. The warning message may include a summary of the one or more quality concerns and potential impact of the one or more quality concerns. For example, for a heat monitoring device as a target product, a warming message may be “ATTENTION: Critical quality concern detected for the heat monitoring device having model number HM-2000. Analysis of recent customer feedback indicates a significant increase in temperature accuracy related issues, with a 40% rise in the last two weeks. The temperature accuracy issue may pose potential safety risks in industrial settings. Immediate investigation and possible recalibration are recommended. Please refer to the attached assessment report for detailed findings and recommended actions. Thus, the present subject matter facilitates proactive identification of quality concerns associated with the target product and facilitates proactive mitigation of the identified quality concerns.

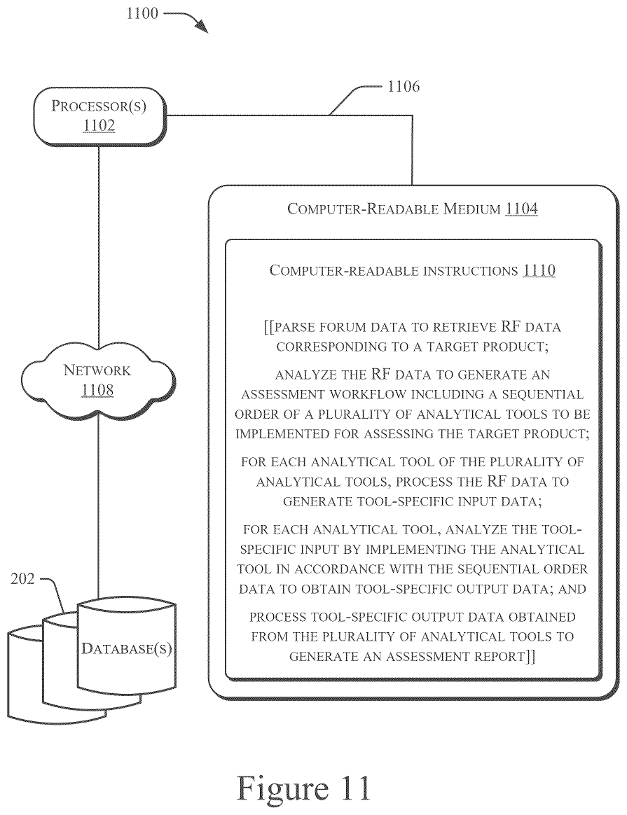

FIG. 11 illustrates a computing environment 1100 implementing a non-transitory computer-readable medium for product risk assessment, according to an example. In an example, the computing environment 1100 includes processor(s) 1102 communicatively coupled to a non-transitory computer-readable medium 1104 through a communication link 1106. In one example, the communication link 1106 may be similar to the communication network 206, as described in conjunction with the preceding figures. In an example implementation, the computing environment 1100 may be for example, the computing environment 200. In an example, the processor(s) 1102 may have one or more processing resources for fetching and executing computer-readable instructions from the non-transitory computer-readable medium 1104. The processor(s) 1102 and the non-transitory computer-readable medium 1104 may be implemented, for example, in the system 100 or by the risk assessment model 302 (as has been described in conjunction with the preceding figures).

The non-transitory computer-readable medium 1104 may be, for example, an internal memory device or an external memory device. In an example implementation, the communication link 1106 may be a network communication link. The processor(s) 1102 and the non-transitory computer-readable medium 1104 may also be communicatively coupled to the database(s) 202 over a network 1108. The network 1108 may be similar to the communication network 206 described in conjunction with FIG. 2.

In an example implementation, the non-transitory computer-readable medium 1104 may include a set of computer-readable instructions 1110 which may be accessed by the processor(s) 1102 through the communication link 1106. Referring to FIG. 11, in an example, the non-transitory computer-readable medium 1104 may include instructions 1110 that may cause the processor(s) 1102 to parse forum data available on a plurality of public forums to retrieve recall and feedback (RF) data corresponding to a target product to be assessed for identifying potential quality concerns in the target product. In one example; the target product may be from any industry, including, but not limited to, a pharmaceutical product, such as a medicine and a medical device, such as a heat monitoring device and a blood glucose monitoring system; an electronic device, such as a wearable fitness tracker and a laptop; an automative, such as a car; an automotive product, such as a clutch; a consumer product, such as a vacuum cleaner and a geyser; and home appliance and automation devices, such as a smart home thermostat and a refrigerator. The plurality of public forums may include any publicly accessible online platforms or digital spaces where information, opinions, experiences, and discussions can be shared about the products, including the target product, manufactured and distributed by the organization. Examples of the plurality of public forums may include, but are not limited to, social media platforms, online review websites, discussion boards, industry-specific forums, product regulatory body databases like food and drug administration (FDA) database, blogs, consumer complaint websites, and product-specific community forums. Thus, the forum data may include information, such as user posts, comments, reviews, ratings, and other forms of user-generated content, available on the plurality of public forums.

In addition to information that is relevant for assessment of the target product, the forum data may include information that is irrelevant for the assessment of the target product. Thus, the forum data may be parsed to retrieve the RF data corresponding to the target product. The RF data may be a subset of the forum data and may include information that is relevant for assessment of the target product. For instance, the RF data may include at least one of public feedback data associated with the target product and historical recall data associated with one or more products having at least one similarity with the target product. The at least one similarity may include similarity in composition, manufacturing process, and/or usage of the one or more products with the target product. The public feedback data may include opinions, comments, reviews, ratings, and discussions of various users about the target product. The historical recall data may encompass the description of investigations carried out and findings documented during historical recalls associated with the one or more products. For example, the historical recall data may include data, such as recall reason, product type, and product description, obtained from an FDA database or a similar database in relation to historical recalls associated with the one or more products. In an example, the RF data may be a processed form of the subset of the forum data that is relevant for assessment of the target product.

Once the RF data is retrieved, the instructions 1110 may cause the processor(s) 1102 to generate an assessment workflow to be followed for assessing the target product. The assessment workflow may include a sequential order of a plurality of analytical tools to be implemented for assessing the target product. Each of the plurality of analytical tools may be configured to utilize a unique technique to comprehend corresponding input data and generate corresponding output data. In an example, each of the plurality of analytical tools may be module(s) designed to process and analyze the corresponding input data according to the unique technique to generate the corresponding output data. The plurality of analytical tools may include a data mining tool, a natural language processing tool, a sentiment analysis tool, a topic modelling tool, a trend analysis tool, a statistical analysis tool, and any other customized tool, such as a customized machine learning tool, specifically configured to process and analyze the RF data in a pre-configured manner.

In an example, for generating the assessment workflow, the instructions 1110 may cause the processor(s) 1102 to classify the RF data into distinct categories and determine the proportion of each of the distinct categories based on the analysis of the RF data. The assessment workflow may be generated based on the distinct categories and the proportion of each of the distinct categories. For instance, upon determining that the RF data contains 60% textual customer reviews, 30% numerical ratings, and 10% image-based feedback about the target product, text analysis tools may be prioritized in the assessment workflow, followed by statistical analysis tools and image processing tools. In another instance, upon determining that the RF data comprises 30% historical recall data from the FDA database, 50% customer reviews from e-commerce platforms, and 20% social media mentions, the assessment workflow may prioritize analytical tools specialized for analysis of the historical recall data, followed by sentiment analysis tools for analysis of the customer reviews, and finally trend analysis tools to process the social media mentions.

In an example, the assessment workflow may be generated based on factors such as reliability of each of the plurality of public forums from which the RF data is retrieved, the distinct categories and the proportion of each of the distinct categories, computational resource requirements, and the potential impact of each distinct category on identification of the potential quality concerns. The assessment workflow may also consider the sequential dependencies between the plurality of analytical tools, prioritizing analysis that provide foundational insights for subsequent analyses using the plurality of analytical tools. Thus, the generated assessment workflow may include a strategically sequenced combination of the plurality of analytical tools such that available data, i.e., the RF data, corresponding to the target product may be efficiently analysed using the plurality of analytical tools for identification of potential quality concerns in the target product.

Once the assessment workflow is generated, the instructions 1110 may cause the processor(s) 1102 to process the RF data to generate tool-specific input data corresponding to each analytical tool of the plurality of analytical tools. The tool-specific input data corresponding to a particular analytical tool, of the plurality of analytical tools, may be data that has been processed, formatted, and structured to meet the specific requirements and constraints of the particular analytical tool, ensuring each of the plurality of analytical tools performs its specialized function effectively within the assessment workflow.

In an example, for generating the tool-specific input data for the analytical tool, the instructions 1110 may cause the processor(s) 1102 to process tool description data corresponding to the analytical tool along with the RF data to determine most appropriate data format and content to be used within the tool-specific input data. The tool description data may include specifications of the analytical tool, input data constraints associated with the analytical tool, and processing capabilities of the analytical tool. For example, for a sentiment analysis tool, tool-specific input data may be generated to include cleaned and standardized text from customer reviews, with content filtered for relevant aspects such as accuracy, battery life, and Bluetooth functionality of the target product, such as the heat monitoring device. Further, for a topic modelling tool, tool-specific input data may be generated to include a corpus of individual feedback documents with stop words removed and words lemmatized, and content filtered for product-specific terminologies.

For each analytical tool of the plurality of analytical tools, the instructions 1110 may cause the processor(s) 1102 to analyze the tool-specific input data by implementing the analytical tool in accordance with the sequential order to obtain tool-specific output data from the analytical tool. The tool-specific output data obtained from the analytical tool may indicate results, insights, or processed information generated by the analytical tool after analyzing the tool-specific input data. For example, the tool-specific output data obtained from the sentiment analysis tool may indicate overall sentiment distribution corresponding to one or more features of the target product. For instance, for a wearable fitness tracker as a target product, the tool-specific output data obtained from the sentiment analysis tool may indicate 60% positive sentiment related to design features of the wearable fitness tracker, 30% negative sentiment focused on syncing issues associated with the wearable fitness tracker, and 10% neutral sentiment. Further, the tool-specific output data obtained from the topic modelling tool may indicate list of key topics discussed in the RF data along with associated keywords found in the RF data. For instance, for a wearable fitness tracker as a target product, the tool-specific output data obtained from the topic modelling tool may indicate topics such as “Bluetooth connectivity issues” with keywords (pairing, disconnect, and range), “Battery life concerns” with keywords (short, drain, charging), and “Audio quality problems” with keywords (static, muffled, bass).

In one example, for each first analytical tool in the sequential order of the plurality of analytical tools, the instructions 1110 may cause the processor(s) 1102 to process the RF data to generate first tool-specific input data corresponding to the first analytical tool. In an example, an AI/ML model, say the risk assessment model 302, may be implemented for processing the RF data to generate the first tool-specific input data. The first tool-specific input data corresponding to the first analytical tool may be data that has been processed, formatted, and structured to meet the specific requirements and constraints of the particular analytical tool, ensuring the first analytical tool performs its specialized function effectively.

Further, for each first analytical tool of the plurality of analytical tools, the instructions 1110 may cause the processor(s) 1102 to analyze the first tool-specific input data by implementing the first analytical tool to obtain first tool-specific output data from the first analytical tool. In an example, the AI/ML model may be implemented for providing the first tool-specific input data to the first analytical tool and obtaining the first tool-specific output data from the first analytical tool. The first tool-specific output data obtained from the first analytical tool may indicate results, insights, or processed information generated by the first analytical tool after analyzing the first tool-specific input data. For example, if the first analytical tool is determined as a sentiment analysis tool, the sentiment analysis tool may analyze the first tool-specific input data, such as 10,000 customer reviews from various sources including e-commerce platforms, social media, and industry forums. Based on analysis of the first tool-specific input data, the sentiment analysis tool may generate the first tool-specific output data that classifies the customer reviews as 55% positive reviews, 35% negative reviews, and 10% neutral reviews, thereby identifying 3,500 negative reviews which may be utilized for further analysis.

For each subsequent analytical tool after the first analytical tool in the sequential order, the instructions 1110 may cause the processor(s) 1102 to process the RF data and tool-specific output data obtained from one or more analytical tools preceding the subsequent analytical tool in the sequential order, to generate subsequent tool-specific input data corresponding to the subsequent analytical tool. In an example, the AI/ML model may be implemented for processing the RF data and the tool-specific output data obtained from the one or more analytical tools to generate the subsequent tool-specific input data. The subsequent tool-specific input data corresponding to the subsequent analytical tool may be data that has been processed, formatted, and structured to meet the specific requirements and constraints of the subsequent analytical tool, ensuring the subsequent analytical tool performs its specialized function effectively.

Further, for each subsequent analytical tool after the first analytical tool in the sequential order, the instructions 1110 may cause the processor(s) 1102 to analyze the subsequent tool-specific input data by implementing the subsequent analytical tool to obtain subsequent tool-specific output data from the analytical tool. The subsequent tool-specific output data obtained from the subsequent analytical tool may indicate results, insights, or processed information generated by the subsequent analytical tool after analyzing the subsequent tool-specific input data. For example, the subsequent tool-specific output data may be obtained from the topic modelling tool by processing the 3,500 negative reviews. The subsequent tool-specific output data obtained from the topic modelling tool may indicate three primary topics including temperature accuracy, battery life, and mobile application connectivity issues associated with the heat monitoring device. For the temperature accuracy issue, the subsequent tool-specific output data obtained from the topic modelling tool may indicate frequently appearing keywords such as “inconsistent”, “drift”, and “calibration”. For the battery life issue, the subsequent tool-specific output data obtained from the topic modelling tool may indicate frequently appearing keywords such as “short duration”, “frequent charging”, and “unexpected shutdowns”. For the mobile application connectivity issue, the subsequent tool-specific output data obtained from the topic modelling tool may indicate frequently appearing keywords such as “disconnects”, “sync failures”, and “data loss”.

The RF data, the first tool-specific output data obtained from the sentiment analysis tool, and the subsequent tool-specific output data obtained from the topic modelling tool may be processed to generate subsequent tool-specific input data corresponding to any other subsequent analytical tool. For example, the RF data, the first tool-specific output data obtained from the sentiment analysis tool, and the subsequent tool-specific output data may be processed to generate subsequent tool-specific input data corresponding to a risk score analysis tool. The risk score analysis tool may be implemented to analyze the subsequent tool-specific input data specifically generated corresponding to the risk score analysis tool. Subsequent tool-specific output data obtained from the risk score analysis tool may indicate risk scores assigned to each of the three primary topics by the risk score analysis tool. For example, based on analysis of the subsequent tool-specific input data corresponding to the risk score analysis tool, the temperature accuracy issue may be assigned a risk score of 8.5 out of 10, the battery life issue may be assigned a risk score of 7.2 out of 10, and the mobile application connectivity issue is assigned a risk score of 6.8 out of 10, reflecting importance of addressing each corresponding primary topic before the corresponding primary topic causes any adverse damage, such as large-scale recalls or consumer safety-concerning accident. In another example, the subsequent tool-specific output data obtained from the risk score analysis tool may indicate risk score for various pre-defined risk indicators corresponding to each of the primary topics identified in the target product. Example of the various pre-defined risk indicators may include, but are not limited to, reputation risks, legal and liability risks, adverse events, performance issues, supply chain risks, product recalls, customer complaints, regulatory violations, quality defects, and safety concerns associated with the target product.

The RF data, the first tool-specific output data obtained from the sentiment analysis tool, and the subsequent tool-specific output data obtained from the topic modelling tool and the risk score analysis tool may be processed to generate subsequent tool-specific input data corresponding to any other subsequent analytical tool. For example, the first tool-specific output data obtained from the sentiment analysis tool and the subsequent tool-specific output data may be processed to generate subsequent tool-specific input data corresponding to a trend analysis tool. The trend analysis tool may be implemented to analyze the subsequent tool-specific input data specifically generated corresponding to the trend analysis tool. Subsequent tool-specific output data obtained from the trend analysis tool may indicate trends and patterns identified by the trend analysis tool in the subsequent tool-specific input data. For example, based on analysis of the subsequent tool-specific input data, such as negative reviews over past three months, corresponding to the trend analysis tool, a sharp 40% increase in negative reviews related to the temperature accuracy issue may be identified over past two weeks, potentially indicating a recent quality control issue or a recent software update issue. Further, a steady 10% rise in negative reviews related to the battery life issue may be identified, indicating that the battery issue is a persistent and growing problem. Further, negative reviews related to the mobile application connectivity issue may be identified to be fluctuating without a clear trend, possibly reflecting intermittent problems or varying user experiences.

In another example, based on analysis of the subsequent tool-specific input data, such as the historical recall data associated with the primary topics identified by the topic modelling tool, the subsequent tool-specific output data obtained from the trend analysis tool may uncover one historical recall for a similar temperature accuracy issue in one of the one or more products, that have at least one similarity with the target product, two years ago. The historical recall may be analyzed to identify that the historical recall occurred due to faulty sensors which led to overheating risks. Further, the subsequent tool-specific output data obtained from the trend analysis tool may indicate that the battery life issue and the mobile application connectivity issue have not resulted in recalls historically, indicating that the battery life issue and the mobile application connectivity issue are less likely to trigger recalls unless safety is directly impacted by the battery life and the mobile application connectivity issues.

Although an exemplary sequential order of the sentiment analysis tool, the topic modelling tool, the risk score analysis tool, and the trend analysis tool has been described, the exemplary sequence order is not intended to be construed as a limitation, and the sentiment analysis tool, the topic modelling tool, the risk score analysis tool, the trend analysis tool, and any other analytical tools may be implemented in a different sequential order to implement the instructions 1110.

In an example, for each public forum of the plurality of public forums, the instructions 1110 may cause the processor(s) 1102 to obtain a corresponding pre-defined importance score assigned to the public forum. In an example, the corresponding pre-defined importance score may be a pre-defined numerical value assigned to the public forum. The corresponding pre-defined importance score may reflect relative significance, credibility, or impact of the public forum in the context of risk assessment of the target product. For example, a popular consumer electronics review website may be one of the plurality of public forums that is assigned an importance score of 0.9 on a scale of 0 to 1, indicating high reliability and relevance of the popular consumer electronics review website. Further, a general social media platform may be one of the plurality of public forums that is assigned an importance score of 0.6, reflecting moderate relevance but potentially lower reliability of the general social media platform. Further, a niche forum dedicated to a specific category, to which the target product belong, may be one of the plurality of public forums that is assigned an importance score of 0.8, due to focused and potentially expert user base of the niche forum dedicated to the specific category. Furthermore, a review section of an e-commerce platform may be one of the plurality of public forums that is assigned an importance score of 0.7, balancing the wide reach of the e-commerce platform with potential biases in customer reviews. Moreover, an FDA database or any other similar database may be one of the plurality of public forums that is assigned an importance score of 0.95, indicating high credibility of the FDA database for being an official source.

In an example, the corresponding pre-defined importance score may be pre-assigned to the public forum by a user, such as a subject matter expert (SME) having knowledge of the plurality of public forums or a user associated with the organization by which the target product is manufactured, or may be pre-generated. For instance, the SME may assign the corresponding pre-defined importance score based on their knowledge of reliability and relevance of the plurality of public forums. In another instance, the corresponding pre-defined importance score may be assigned by conducting surveys among target users to understand which public forums are trusted and relied on for information of the target product. In yet another instance, the corresponding pre-defined importance score may be generated based on analysis of historical performance information indicating how accurately different public forums have predicted or identified quality concerns in the past. In yet another instance, the corresponding pre-defined importance score may be generated based on analysis, utilizing machine learning techniques, of the correlation between data from different public forums and actual product quality concerns. In an example, the corresponding pre-defined importance score may be adjusted over time based on the accuracy and timeliness of information from each of the plurality of public forums. In an example, the corresponding pre-defined importance score may be obtained directly from the user. In another example, the corresponding pre-defined importance score may be pre-stored in a memory, say the memory 212, of the system 100 and may be obtained from the memory.

The instructions 1110 may cause the processor(s) 1102 to generate the tool-specific input data corresponding to the analytical tool based on pre-defined importance scores assigned to the plurality of public forums. Thus, pre-defined importance scores assigned to the plurality of public forums may be used to weigh the contribution of data from different public forums when generating the tool-specific input data for each of the plurality of analytical tools. For example, while generating the tool-specific input data corresponding to the trend analysis tool, information available on the FDA database regarding a particular issue, such as the temperature accuracy issue, may be given more weightage than information available on the general social media platform regarding the particular issue.

In an example, the plurality of analytical tools may include at least the topic modelling tool. For generating tool-specific input data corresponding to the topic modelling tool, the instructions 1110 may cause the processor(s) 1102 to process at least the RF data to determine relevant data including one or more negative feedbacks about the target product. In an example, tool-specific output data obtained from one or more analytical tools preceding the topic modelling tool in the sequential order may be processed along with the RF data to determine the relevant data. Each of the one or more negative feedbacks may indicate at least one quality concern in the target product. In an example, the one or more negative feedbacks about the target product may include critical, unfavourable, or dissatisfied comments, reviews, or reports from users, customers, or stakeholders that highlight issues, shortcomings, or problems with performance, quality, safety, or user experience of the target product. For example, for a heat monitoring device as a target product, the one or more negative feedbacks may include a first negative feedback “The temperature readings are consistently off by 5-10 degrees, making it unreliable for precise monitoring in our factory”, a second negative feedback “Battery life is much shorter than advertised. It barely lasts a full shift, which is unacceptable for continuous monitoring”, a third negative feedback “The mobile app keeps crashing when I try to sync data, causing us to lose critical temperature logs”, a fourth negative feedback “Device stopped working after exposure to high humidity, despite being marketed as suitable for industrial environments”, a fifth negative feedback “Alarm function failed to trigger when temperatures exceeded the set threshold, posing a serious safety risk in our facility”, and other similar negative feedbacks.

The instructions 1110 may cause the processor(s) 1102 to generate tool-specific input data corresponding to the topic modelling tool using the relevant data. In an example, the relevant data may be pre-processed using various pre-processing techniques, such as data cleaning, formatting, feature extraction, and normalization, to generate the tool-specific input data corresponding to the topic modelling tool. Tool-specific output data obtained from the topic modelling tool based on analysis of the tool-specific input data may indicate one or more key quality concerns discussed in the negative feedbacks. The one or more key concerns may include primary issues related to quality, performance, or safety of the target product that emerge as distinct themes or topics. The one or more key concerns may be extracted and grouped by the topic modelling tool based on the frequency and co-occurrence of specific words or phrases in the negative feedbacks.

For example, the tool-specific output data obtained from the topic modelling tool based on analysis of negative feedbacks about a heat monitoring device may indicate three key quality concerns including temperature accuracy, battery life, and mobile application connectivity issues associated with the heat monitoring device. The temperature accuracy issue may be determined based on identification of a cluster of keywords, such as “inaccurate”, “inconsistent”, “deviation”, “drift”, and “calibration”, frequently appearing in the negative feedbacks, indicating a key concern about the ability of the heat monitoring device to provide precise temperature readings. Further, the battery life issue may be determined based on identification of a cluster of keywords, such as “short duration”, “dies quickly”, “power issues”, “frequent charging”, and “unexpected shutdowns”, frequently appearing in the negative feedbacks, highlighting a key concern about the power management and longevity during use of the heat monitoring device. Furthermore, the mobile application connectivity issue may be determined based on identification of a cluster of keywords, such as “disconnects”, “app crashes”, “sync failures”, “connectivity issues”, and “data loss” frequently appearing in the negative feedbacks, indicating a key concern about the reliability of accompanying software or mobile application of the heat monitoring device.

In an example, the plurality of analytical tools may include at least the sentiment analysis tool. For generating tool-specific input data corresponding to the sentiment analysis tool, the instructions 1110 may cause the processor(s) 1102 to process at least the RF data to determine relevant data including customer feedbacks about the target product. In an example, tool-specific output data obtained from one or more analytical tools preceding the sentiment analysis tool in the sequential order may be processed along with the RF data to determine the relevant data. Each of the one or more negative feedbacks may indicate at least one quality concern in the target product. In an example, customer feedbacks about the target product may include opinions, comments, reviews, ratings, and experiences shared by users or consumers about the target product. The customer feedbacks can be positive, negative, or neutral, and may cover various aspects of the target product including the performance, quality, usability, and overall satisfaction of the target product. For example, for a heat monitoring device as a target product, the customer feedbacks may include a first customer feedback “The device is okay, but the battery life could be better. I find myself charging it more often than I would like”, a second customer feedback “I am pleased with this device. It performs well, has good battery life, and the app is user-friendly. It meets our needs effectively”, a third customer feedback “While the accuracy of the device is excellent, the short battery life is a significant drawback. It's a mix of great features and frustrating limitations”, a fourth customer feedback “This is the worst product I have ever purchased. It is completely unreliable, the customer service is terrible, and it is a waste of money. I strongly advise against buying it”, a fifth customer feedback “The heat monitor works as expected. It is neither exceptional nor disappointing. It does the job it is supposed to do”, a sixth customer feedback “This heat monitor is absolutely fantastic! It is incredibly accurate, easy to use, and has revolutionized our temperature management process. Best purchase we've made for our facility”, a seventh customer feedback “I am not satisfied with this heat monitor. The readings are inconsistent, and the app frequently crashes. It is causing more problems than it solves”, and other similar customer feedbacks.

The instructions 1110 may cause the processor(s) 1102 to generate tool-specific input data corresponding to the sentiment analysis tool using the relevant data. In an example, the relevant data may be pre-processed using various pre-processing techniques, such as data cleaning, formatting, feature extraction, and normalization, to generate the tool-specific input data corresponding to the sentiment analysis tool. Tool-specific output data obtained from the sentiment analysis tool based on analysis of the tool-specific input data may indicate different categories of sentiments emerging in the customer feedbacks. The different categories of sentiments may include various emotional tones or attitudes expressed in the customer feedbacks about the target product. In an example, the different categories of sentiments may range from highly positive to highly negative, with neutral sentiments in between. The sentiment analysis tool may classifies the customer feedbacks into the different categories to provide a comprehensive overview of customer opinions. Examples of the different categories of sentiments may include, but are not limited to, highly positive, positive, neutral, slightly negative, negative, highly negative, and mixed.

For example, the tool-specific output data obtained from the sentiment analysis tool based on analysis of customer feedbacks about the heat monitoring device may indicate the first customer feedback to be slightly negative, the second customer feedback to be positive, the third customer feedback to be mixed, the fourth customer feedback to be highly negative, the fifth customer feedback to be neutral, the sixth customer feedback to be highly positive, and the seventh customer feedback to be negative.

The instructions 1110 may cause the processor(s) 1102 to process tool-specific output data obtained from the plurality of analytical tools to identify probable quality concerns in the target product. The probable quality concerns may be defined as potential issues or defects in the target product that are likely to affect the performance, safety, or user satisfaction associated with the target product. The probable quality concerns may have a significant likelihood of being genuine problems that may require attention or intervention to prevent large-scale recall of the target product. For example, for a heat monitoring device, a probable quality concern may be inconsistent temperature readings at high temperatures. The probable quality concern in the heat monitoring device may be identified through analysis of user reviews reporting discrepancies in the temperature readings, coupled with an increasing trend in complaints related to inaccurate temperature readings for the one or more products that have at least one similarity with the target product and a high risk score associated with temperature accuracy issues.

Further, the instructions 1110 may cause the processor(s) 1102 to process tool-specific output data obtained from the plurality of analytical tools to generate an assessment report, including the probable quality concerns, corresponding to the target product. The assessment report may be a comprehensive document that summarizes findings, analysis, and recommendations resulting from a systematic evaluation of quality, performance, and potential risks associated with the target product, by implementing the plurality of analytical tools in accordance with the assessment workflow. The assessment report may include data-driven insights, the potential quality concerns, severity and trends of the potential quality concerns, historical context associated with the potential quality concerns, and suggested actions for addressing the potential quality concerns. For example, an assessment report for a heat monitoring device may include sections on overall sentiment analysis (e.g., 55% positive reviews), the potential quality concerns (e.g., temperature accuracy, battery life, mobile application connectivity), risk scores for each of the potential quality concerns, trend analysis showing a 40% increase in temperature accuracy related recalls or complaints, and recommendations such as urgent investigation into temperature sensor calibration and firmware updates for battery optimization.

In an example, the instructions 1110 may cause the processor(s) 1102 to generate one or more recommendations to mitigate the probable quality concerns in the target product. In an example, the one or more recommendations may include suggested actions, strategies, or solutions proposed to address, reduce, or eliminate the probable quality concerns identified in the target product. In an example, the one or more recommendations may be generated based on analysis of at least one of the RF data and historical actionable data describing historical actions, strategies, or solutions historically implemented to address quality concerns similar to the probable quality concerns.

The instructions 1110 may cause the processor(s) 1102 to incorporate the one or more recommendations in the assessment report. In an example, the assessment report may include one or more sections corresponding to the one or more recommendations. For example, for a heat monitoring device as a target product, the assessment report may include a first section stating, “a firmware update may be implemented to recalibrate temperature sensors across all target devices to address the temperature accuracy issue”. Further, the assessment report may include a second section stating, “quality control processes in the production line may be enhanced to focus on temperature sensor testing under various environmental conditions for addressing the temperature accuracy issue”. Further, the assessment report may include a third section stating, “a user guide may be developed and distributed for proper device placement and maintenance to minimize external factors affecting the accuracy of the temperature sensors”. Furthermore, the assessment report may include a fourth section stating, “a voluntary inspection program may be initiated for the heat monitoring devices already in use, offering free recalibration services if needed”. Moreover, the assessment report may include a fifth section stating, “a dedicated support hotline may be established for users experiencing temperature accuracy issues, providing real-time troubleshooting and data collection for further analysis”.

In an example, the instructions 1110 may cause the processor(s) 1102 to analyze the assessment report to ascertain whether the assessment report indicates any quality concern corresponding to the target product. The assessment report may indicate one or more quality concern corresponding to the target product when the one or more quality concerns are identified by the system 100 during risk assessment of the target product. The assessment report may not indicate any quality concern when any quality concern is not identified by the system 100 during risk assessment of the target product.

Upon ascertaining that the assessment report does not indicate any quality concern corresponding to the target product, the instructions 1110 may cause the processor(s) 1102 to forgo generating any warning message.

However, upon ascertaining the assessment report to indicate one or more quality concerns corresponding to the target product, the instructions 1110 may cause the processor(s) 1102 to generate a warning message, for transmission to a user, to alert the user about the one or more quality concerns. The warning message may include the assessment report. In an example, the warning message may be a proactive alert generated by the system 100 to notify users or stakeholders about the one or more quality concerns identified during the risk assessment of the target product. The warning message may include a summary of the one or more quality concerns and potential impact of the one or more quality concerns. For example, for a heat monitoring device as a target product, a warming message may be “ATTENTION: Critical quality concern detected for the heat monitoring device having model number HM-2000. Analysis of recent customer feedback indicates a significant increase in temperature accuracy related issues, with a 40% rise in the last two weeks. The temperature accuracy issue may pose potential safety risks in industrial settings. Immediate investigation and possible recalibration are recommended. Please refer to the attached assessment report for detailed findings and recommended actions”. In one example, the warning message may be stored within the assessment report data 122. Thus, the present subject matter facilitates proactive identification of quality concerns associated with the target product and facilitates proactive mitigation of the identified quality concerns.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a data acquisition engine to:
parse forum data available on a plurality of public forums to retrieve recall and feedback (RF) data corresponding to a target product to be assessed for identifying potential quality concerns in the target product;
a tool identification engine to:
analyze the RF data to generate an assessment workflow to be followed for assessing the target product, the assessment workflow including a sequential order of a plurality of analytical tools to be implemented for assessing the target product, wherein each of the plurality of analytical tools is configured to utilize a unique technique to comprehend corresponding input data and generate corresponding output data;
a tool implementation engine to:
for each analytical tool of the plurality of analytical tools:
process the RF data to generate tool-specific input data corresponding to the analytical tool; and
analyze the tool-specific input data by implementing the analytical tool in accordance with the sequential order to obtain tool-specific output data from the analytical tool; and
a report generation engine to:
process tool-specific output data obtained from the plurality of analytical tools to identify probable quality concerns in the target product and generate an assessment report, including the probable quality concerns, corresponding to the target product.

2. The system of claim 1, wherein the RF data includes at least one of:
public feedback data associated with the target product; and
historical recall data associated with one or more products having at least one similarity with the target product.

3. The system of claim 1, wherein the tool implementation engine is to:
for each public forum of the plurality of public forums, obtain a corresponding pre-defined importance score assigned to the public forum; and
generate the tool-specific input data corresponding to the analytical tool based on pre-defined importance scores assigned to the plurality of public forums.

4. The system of claim 1, wherein the system comprises a warning generation engine to:
analyze the assessment report to ascertain whether the assessment report indicates any quality concern corresponding to the target product; and
upon ascertaining the assessment report to indicate one or more quality concerns corresponding to the target product, generate a warning message, for transmission to a user, to alert the user about the one or more quality concerns, the warning message including the assessment report.

5. The system of claim 1, wherein the report generation engine is to:
generate one or more recommendations to mitigate the probable quality concerns in the target product; and
incorporate the one or more recommendations in the assessment report.

6. The system of claim 1, wherein the plurality of analytical tools includes at least a topic modelling tool, and wherein the tool implementation engine is to:
process the RF data to determine relevant data including one or more negative feedbacks about the target product, wherein each of the one or more negative feedbacks indicates at least one quality concern in the target product; and
generate the tool-specific input data corresponding to the topic modelling tool using the relevant data, wherein the tool-specific output data obtained from the topic modelling tool indicates one or more key quality concerns discussed in the negative feedbacks.

7. The system of claim 1, wherein the plurality of analytical tools includes at least a sentiment analysis tool, and wherein the tool implementation engine is to:
process the RF data to determine relevant data including customer feedbacks about the target product; and
generate the tool-specific input data corresponding to the sentiment analysis tool using the relevant data, wherein the tool-specific output data obtained from the sentiment analysis tool indicates different categories of sentiments emerging in the customer feedbacks.

8. A method comprising:
parsing forum data available on a plurality of public forums to retrieve recall and feedback (RF) data corresponding to a target product to be assessed for identifying potential quality concerns in the target product;
analyzing the RF data to identify a plurality of analytical tools to be implemented for assessing the target product and determine a sequential order of the plurality of analytical tools to be followed for assessing the target product, wherein each of the plurality of analytical tools is configured to utilize a unique technique to comprehend corresponding input data and generate corresponding output data;
for each first analytical tool in the sequential order of the plurality of analytical tools:
processing the RF data to generate first tool-specific input data corresponding to the first analytical tool; and
analyzing the first tool-specific input data by implementing the first analytical tool to obtain first tool-specific output data from the first analytical tool;
for each subsequent analytical tool after the first analytical tool in the sequential order:
processing the RF data and tool-specific output data obtained from one or more analytical tools preceding the subsequent analytical tool in the sequential order, to generate subsequent tool-specific input data corresponding to the subsequent analytical tool; and
analyzing the subsequent tool-specific input data by implementing the subsequent analytical tool to obtain subsequent tool-specific output data from the analytical tool; and
processing tool-specific output data obtained from the plurality of analytical tools to identify probable quality concerns in the target product and generate an assessment report, including the probable quality concerns, corresponding to the target product.

9. The method of claim 8, wherein the RF data includes at least one of:
public feedback data associated with the target product; and
historical recall data associated with one or more products having at least one similarity with the target product.

10. The method of claim 8, wherein the method comprises:
for each public forum of the plurality of public forums, obtaining a corresponding pre-defined importance score assigned to the public forum; and
generating the tool-specific input data, including the first tool-specific data, corresponding to each of the plurality of analytical tools based on pre-defined importance scores assigned to the plurality of public forums.

11. The method of claim 8, wherein the method comprises:
analyzing the assessment report to ascertain whether the assessment report indicates any quality concern corresponding to the target product; and
upon ascertaining the assessment report to indicate one or more quality concerns corresponding to the target product, generating a warning message, for transmission to a user, to alert the user about the one or more quality concerns, the warning message including the assessment report.

12. The method of claim 8, wherein the method comprises:
generating one or more recommendations to mitigate the probable quality concerns in the target product; and
incorporating the one or more recommendations in the assessment report.

13. The method of claim 8, wherein the plurality of analytical tools includes at least a topic modelling tool, and wherein the method comprises:
processing at least the RF data to determine relevant data including one or more negative feedbacks about the target product, wherein each of the one or more negative feedbacks indicates at least one quality concern in the target product; and
generating tool-specific input data corresponding to the topic modelling tool using the relevant data, wherein tool-specific output data obtained from the topic modelling tool indicates one or more key quality concerns discussed in the negative feedbacks.

14. A non-transitory computer-readable medium comprising instructions for product risk assessment, the instructions being executable by a processing resource to:
parse forum data available on a plurality of public forums to retrieve recall and feedback (RF) data corresponding to a target product to be assessed for identifying potential quality concerns in the target product;
analyze the RF data to generate an assessment workflow to be followed for assessing the target product, the assessment workflow including a sequential order of a plurality of analytical tools to be implemented for assessing the target product, wherein each of the plurality of analytical tools is configured to utilize a unique technique to comprehend corresponding input data and generate corresponding output data;
for each analytical tool of the plurality of analytical tools:
process the RF data to generate tool-specific input data corresponding to the analytical tool; and
analyze the tool-specific input data by implementing the analytical tool in accordance with the sequential order to obtain tool-specific output data from the analytical tool; and
process tool-specific output data obtained from the plurality of analytical tools to identify probable quality concerns in the target product and generate an assessment report, including the probable quality concerns, corresponding to the target product.

15. The non-transitory computer-readable medium of claim 14, wherein the RF data includes at least one of:
public feedback data associated with the target product; and
historical recall data associated with one or more products having at least one similarity with the target product.

16. The non-transitory computer-readable medium of claim 14, wherein the instructions are executable by the processing resource to:
for each public forum of the plurality of public forums, obtain a corresponding pre-defined importance score assigned to the public forum; and
generate the tool-specific input data corresponding to the analytical tool based on pre-defined importance scores assigned to the plurality of public forums.

17. The non-transitory computer-readable medium of claim 14, wherein the instructions are executable by the processing resource to:
analyze the assessment report to ascertain whether the assessment report indicates any quality concern corresponding to the target product; and
upon ascertaining the assessment report to indicate one or more quality concerns corresponding to the target product, generate a warning message, for transmission to a user, to alert the user about the one or more quality concerns, the warning message including the assessment report.

18. The non-transitory computer-readable medium of claim 14, wherein the instructions are executable by the processing resource to:
generate one or more recommendations to mitigate the probable quality concerns in the target product; and
incorporate the one or more recommendations in the assessment report.

19. The non-transitory computer-readable medium of claim 14, wherein the plurality of analytical tools includes at least a topic modelling tool, and wherein the instructions are executable by the processing resource to:
process the RF data to determine relevant data including one or more negative feedbacks about the target product, wherein each of the one or more negative feedbacks indicates at least one quality concern in the target product; and
generate the tool-specific input data corresponding to the topic modelling tool using the relevant data, wherein the tool-specific output data obtained from the topic modelling tool indicates one or more key quality concerns discussed in the negative feedbacks.

20. The non-transitory computer-readable medium of claim 14, wherein the plurality of analytical tools includes at least a sentiment analysis tool, and wherein the instructions are executable by the processing resource to:
process the RF data to determine relevant data including customer feedbacks about the target product; and
generate the tool-specific input data corresponding to the sentiment analysis tool using the relevant data, wherein the tool-specific output data obtained from the sentiment analysis tool indicates different categories of sentiments emerging in the customer feedbacks.
